(19) United States
(12) Patent Application Publication
(10) Pub. No.: US 2025/0181129 A1
(43) Pub. Date: Jun. 5, 2025

(54) SATELLITE INTERNET CONSTELLATION CONTENT DELIVERY NETWORK AND DATA CENTER

(71) Applicant: Armada Systems Inc., Greebrae, CA (US)

(72) Inventor: Stuart Alexander Jacobson, San Francisco, CA (US)

(21) Appl. No.: 18/843,206

(22) PCT Filed: May 10, 2023
(86) PCT No.: PCT/US2023/066846

§ 371 Date: Aug. 30, 2024

Related U.S. Application Data
(60) Provisional application No. 63/340,614, filed on May 11, 2022.

(51) Int. Cl. G06F 1/26; G06F 1/20

(52) U.S. Cl. CPC G06F 1/26; G06F 1/20

(57) ABSTRACT

A plurality of computational units provided within a housing of a grid-independent mobile data center apparatus are configured to implement an edge data center. An onboard energy generation system is deployable from the housing and generates electrical energy for powering at least the plurality of computational units. A cooling system is powered by the onboard energy generation system. One or more battery systems store electrical energy generated by the onboard energy generation system. A communications system includes one or more satellite transceivers each associated with a satellite internet constellation and configured to provide data connectivity between the satellite internet constellation and the plurality of computational units. One or more propulsion systems are coupled to the housing and configured to move the grid-independent mobile data center apparatus within a surrounding environment utilizing electrical energy from the onboard energy generation system.

### CROSS-REFERENCE TO RELATED APPLICATIONS

This application claims the benefit of priority to U.S. Provisional Patent Application No. 63/340,614 filed May 11, 2022, and entitled “VEHICLE-BASED SATELLITE CLOUD SERVICES,” the disclosure of which is herein incorporated by reference in its entirety.

### TECHNICAL FIELD

The present disclosure pertains to wireless communications, and more specifically pertains to a data center apparatus with satellite constellation data network connectivity.

### BACKGROUND

Low-orbit satellite constellation systems have been rapidly developed and deployed to provide wireless communications and data network connectivity. For instance, low-orbit satellite constellation systems (collectively referred to herein as “satellite constellations”) can include a plurality of discrete satellites arranged in a low-earth orbit (LEO), for example within the range of 500 km-1500 km. At an altitude of approximately 500 km above the surface of the Earth, the round trip latency between an LEO satellite and a terrestrial transceiver (e.g., transmitter and/or receiver) is often on the order of 20 milliseconds. By comparison, existing geosynchronous satellites orbit the Earth at 35,786 km and may have a round trip latency of 600 milliseconds or more.

The fleet of discrete satellites (also referred to as “birds”) included in a satellite constellation can be arranged as a global satellite constellation that provides at least periodic or intermittent coverage to a large portion of the Earth's surface. In many cases, at least certain areas of the Earth's surface may have continuous or near-continuous coverage from at least one bird of the satellite constellation. For instance, a global satellite constellation can be formed based on a stable (and therefore predictable) space geometric configuration, in which the fleet of birds maintain fixed space-time relationships with one another. A satellite constellation be used to provide data network connectivity to ground-based devices and/or other terrestrial receivers. For example, a satellite constellation can be integrated with or otherwise provide connectivity to one or more terrestrial (e.g., on-ground) data networks, such as the internet, a 4G/LTE network, and/or a 5G/NR network, among various others.

Satellite constellations can be used to provide data connectivity to and between existing computing infrastructure, including data centers and other physical server deployments as well as cloud and other virtualized deployments. Existing data centers and other physical server deployments are often provided in locations with readily available, and typically relatively inexpensive, access to electrical power. Existing data centers and physical server deployments are also often provided in locations with high bandwidth and/or low latency internet connections. Based on these dual power and connectivity needs, data centers and physical server deployments at scale are often concentrated in only a few different geographic locations that can meet both needs. Cloud and other virtualized deployments often exhibit the same location-based constraints, as the cloud operator (e.g., cloud infrastructure provider) utilizes a physical data center or server deployment subject to the same power and connectivity needs noted above.

### BRIEF SUMMARY

In some examples, systems and techniques are described for a grid-independent mobile data center apparatus. According to at least one illustrative example, a grid-independent mobile data center apparatus is provided, the apparatus comprising: a housing; a plurality of computational units provided within an interior volume of the housing and configured to implement an edge data center; an onboard energy generation system deployable from the housing and configured to generate electrical energy for powering at least the plurality of computational units; a cooling system associated with the plurality of computational units and powered by the onboard energy generation system; one or more battery systems configured to store electrical energy generated by the onboard energy generation system; a communications system including one or more satellite transceivers, each satellite transceiver of the one or more satellite transceivers associated with a satellite internet constellation and configured to provide data connectivity between the satellite internet constellation and the plurality of computational units; and one or more propulsion systems coupled to the housing, the one or more propulsion systems configured to move the housing within a surrounding environment utilizing electrical energy from the onboard energy generation system.

In some aspects, the techniques described herein relate to a grid-independent mobile data center apparatus, wherein the one or more propulsion systems: receive electrical energy generated by the onboard energy generation system; or receive electrical energy discharged from the one or more battery systems.

In some aspects, the techniques described herein relate to a grid-independent mobile data center apparatus, wherein the one or more propulsion systems include one or more electric motors disposed within the housing and configured to generate horizontal translational forces for moving the grid-independent mobile data center apparatus from a first location to a second location different from the first location.

In some aspects, the techniques described herein relate to a grid-independent mobile data center apparatus, wherein the one or more electric motors are coupled to a drivetrain of the housing having a plurality of wheels or treads.

In some aspects, the techniques described herein relate to a grid-independent mobile data center apparatus, wherein: the one or more electric motors are coupled to a propellor or blower fan mounted on the housing; and the housing is included in a water-going vessel or a hovercraft.

In some aspects, the techniques described herein relate to a grid-independent mobile data center apparatus, wherein: the onboard energy generation system is configured to generate electrical energy for powering the plurality of computational units and the grid-independent mobile data center apparatus.

In some aspects, the techniques described herein relate to a grid-independent mobile data center apparatus, further including: an electrical distribution bus coupled to each electrical-powered component included in the grid-independent mobile data center apparatus; wherein the electrical distribution bus selectively receives electrical power as input from one or more of the onboard energy generation system and the one or more battery systems.

In some aspects, the techniques described herein relate to a grid-independent mobile data center apparatus, further including: one or more internal combustion engine (ICE) generators configured to generate electrical energy for powering the grid-independent mobile data center apparatus or for charging the one or more battery systems; and a fuel storage tank attached to the housing and coupled to the one or more ICE generators to provide fuel.

In some aspects, the techniques described herein relate to a grid-independent mobile data center apparatus, wherein the one or more ICE generators are automatically powered on based on a determination that an electrical load associated with the grid-independent mobile data center apparatus is greater than a threshold amount of a maximum output load currently associated with the onboard energy generation system.

In some aspects, the techniques described herein relate to a grid-independent mobile data center apparatus, wherein the one or more propulsion systems include an axis tracking system configured to rotate the housing about one or more axes of the housing

In some aspects, the techniques described herein relate to a grid-independent mobile data center apparatus, wherein the axis tracking system rotates the housing to achieve a particular orientation of the onboard energy generation system when the onboard energy generation system is deployed from the housing.

In some aspects, the techniques described herein relate to a grid-independent mobile data center apparatus, wherein: the onboard energy generation system includes one or more solar panels arranged on a plurality of solar panel platforms deployable from the housing; a yaw axis tracking motor of the axis tracking system is configured to yaw the housing based on a determined solar position relative to the housing; and a pitch axis tracking motor of the axis tracking system is configured to adjust a pitch of the housing away from level based on an angle formed between incident sunlight and the plurality of solar panel platforms.

In some aspects, the techniques described herein relate to a grid-independent mobile data center apparatus, wherein: the onboard energy generation system includes one or more wind turbines or rotors coupled to an outer surface of the housing; and a yaw axis tracking motor of the axis tracking system is configured to yaw the housing based on a determined wind direction associated with measured winds acting on the housing.

In some aspects, the techniques described herein relate to a grid-independent mobile data center apparatus, wherein the one or more wind turbines or rotors include a fan associated with the cooling system, the fan configured to: dissipate waste heat from an interior volume of the housing when coupled to the onboard energy generation system; and generate additional electrical energy based on being de-coupled from the onboard energy generation system and being coupled to the one or more battery systems.

In some aspects, the techniques described herein relate to a grid-independent mobile data center apparatus, wherein the edge data center implemented by the plurality of computational units is a content delivery network (CDN) node associated with the satellite internet constellation.

In some aspects, the techniques described herein relate to a grid-independent mobile data center apparatus, wherein the grid-independent mobile data center apparatus is included in a fleet including a plurality of grid-independent mobile data center apparatuses.

In some aspects, the techniques described herein relate to a grid-independent mobile data center apparatus, wherein the communications system includes one or more backhaul transceivers configured for point-to-point and relay communications between the grid-independent mobile data center apparatus and additional grid-independent mobile data center apparatuses included in the fleet.

In some aspects, the techniques described herein relate to a grid-independent mobile data center apparatus, wherein the one or backhaul transceivers include one or more of a microwave transceiver or a free space optical (FSO) transceiver coupled to the housing.

In some aspects, the techniques described herein relate to a grid-independent mobile data center apparatus, wherein the communications system includes a first satellite transceiver configured for communication with a first satellite internet constellation and a second satellite transceiver configured for communication with a second satellite internet constellation different from the first satellite internet constellation.

In some aspects, the techniques described herein relate to a grid-independent mobile data center apparatus, wherein the communications system includes a first satellite receiver configured to receive communications from the satellite internet constellation and a second satellite receiver configured to transmit communications to the satellite internet constellation.

In some aspects, the techniques described herein relate to a grid-independent mobile data center apparatus, wherein each satellite transceiver of the one or more satellite transceivers is configured to transmit and receive packet network data traffic from a first bird included in the satellite internet constellation, wherein the first bird communicates with a terrestrial internet gateway connected to a second bird included in the satellite internet constellation.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. The use of a same reference numbers in different drawings indicates similar or identical items or features. Understanding that these drawings depict only exemplary embodiments of the disclosure and are not therefore to be considered to be limiting of its scope, the principles herein are described and explained with additional specificity and detail through the use of the accompanying drawings in which:

FIG. 1 depicts an example design of a base station and a user equipment (UE) for transmission and processing of signals exchanged between the UE and the base station, in accordance with some examples;

FIG. 2 is a diagram illustrating an example configuration of a Non-Terrestrial Network (NTN) for providing data network connectivity to terrestrial (ground-based) devices, in accordance with some examples;

FIG. 3 is a diagram illustrating an example of a satellite internet constellation content delivery network (CDN) that can be used to provide low latency satellite internet connectivity, in accordance with some examples;

FIG. 4A is a diagram illustrating an example configuration of polygon layers of satellite dishes that may be utilized at client-side location(s) and/or server-side location(s) associated with a satellite internet constellation, in accordance with some examples;

FIG. 4B is a diagram illustrating another example configuration of polygon layers of satellite dishes that may be utilized at client-side location(s) and/or server-side location(s) associated with a satellite internet constellation, in accordance with some examples;

FIG. 5 is a block diagram illustrating an example architecture of a grid-independent edge computing device with satellite constellation data network connectivity, in accordance with some examples;

FIG. 6 is a diagram illustrating an example of a grid-independent edge computing device implemented using a towable housing that includes one or more deployable energy generation modules, in accordance with some examples;

FIG. 7 is a diagram illustrating an example of a grid-independent edge computing device implemented using a water-going vessel housing, in accordance with some examples;

FIG. 8A is a diagram illustrating an example housing of a grid-independent edge computing device, in accordance with some examples;

FIG. 8B is a diagram illustrating example configurations of deployable solar panels provided on a housing of a grid-independent edge computing device, in accordance with some examples;

FIG. 9 is a diagram illustrating additional example configurations of deployable solar panels provided on a housing of a grid-independent edge computing device, in accordance with some examples; and

FIG. 10 is a block diagram illustrating an example of a computing system architecture that can be used to implement one or more aspects described herein, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

The term “network entity” or “base station” may refer to a single physical Transmission-Reception Point (TRP) or to multiple physical Transmission-Reception Points (TRPs) that may or may not be co-located. For example, where the term “network entity” or “base station” refers to a single physical TRP, the physical TRP may be an antenna of a base station (e.g., satellite constellation ground station/internet gateway) corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Because a TRP is the point from which a base station transmits and receives wireless signals, as used herein, references to transmission from or reception at a base station are to be understood as referring to a particular TRP of the base station.

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

Further details regarding the systems and techniques described herein will be discussed below with respect to the figures.

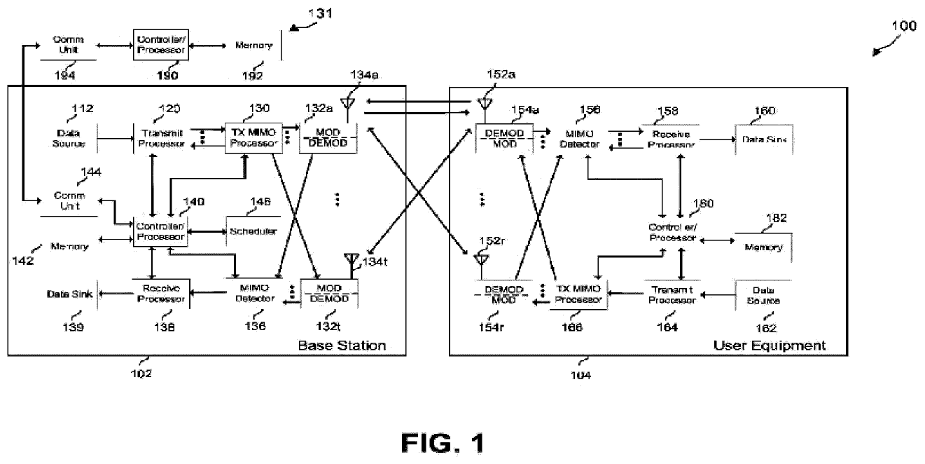

FIG. 1 shows a block diagram of a design of a base station 102 and a UE 104 that enable transmission and processing of signals exchanged between the UE and the base station, in accordance with some aspects of the present disclosure. Design 100 includes components of a base station 102 and a UE 104. In some examples, the architecture of base station 102 can be the same as or similar to an architecture used to implement a satellite constellation ground station (e.g., internet gateway for providing internet connectivity via a satellite constellation). In some examples, the architecture of base station 102 can be the same as or similar to an architecture used to implement a satellite of a satellite constellation.

As illustrated, base station 102 may be equipped with T antennas 134a through 134t, and UE 104 may be equipped with R antennas 152a through 152r, where in general T≥1 and R≥1. At base station 102, a transmit processor 120 may receive data from a data source 112 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 120 may also process system information (e.g., for semi-static resource partitioning information (SRPI) and/or the like) and control information (e.g., CQI requests, grants, upper layer signaling, and/or the like) and provide overhead symbols and control symbols. Transmit processor 120 may also generate reference symbols for reference signals (e.g., the cell-specific reference signal (CRS)) and synchronization signals (e.g., the primary synchronization signal (PSS) and secondary synchronization signal (SSS))). A transmit (TX) multiple-input multiple-output (MIMO) processor 130 may perform spatial processing (e.g., precoding) on the data symbols, the control symbols, the overhead symbols, and/or the reference symbols, if applicable, and may provide T output symbol streams to T modulators (MODs) 132a through 132t. The modulators 132a through 132t are shown as a combined modulator-demodulator (MOD-DEMOD). In some cases, the modulators and demodulators can be separate components. Each modulator of the modulators 132a to 132t may process a respective output symbol stream, e.g., for an orthogonal frequency-division multiplexing (OFDM) scheme and/or the like, to obtain an output sample stream. Each modulator of the modulators 132a to 132t may further process (e.g., convert to analog, amplify, filter, and upconvert) the output sample stream to obtain a downlink signal. T downlink signals may be transmitted from modulators 132a to 132t via T antennas 134a through 134t, respectively. According to certain aspects described in more detail below, the synchronization signals can be generated with location encoding to convey additional information.

At UE 104, antennas 152a through 152r may receive the downlink signals from base station 102 and/or other base stations and may provide received signals to demodulators (DEMODs) 154a through 154r, respectively. The demodulators 154a through 154r are shown as a combined modulator-demodulator (MOD-DEMOD). In some cases, the modulators and demodulators can be separate components. Each demodulator of the demodulators 154a through 154r may condition (e.g., filter, amplify, downconvert, and digitize) a received signal to obtain input samples. Each demodulator of the demodulators 154a through 154r may further process the input samples (e.g., for OFDM and/or the like) to obtain received symbols. A MIMO detector 156 may obtain received symbols from all R demodulators 154a through 154r, perform MIMO detection on the received symbols if applicable, and provide detected symbols. A receive processor 158 may process (e.g., demodulate and decode) the detected symbols, provide decoded data for UE 104 to a data sink 160, and provide decoded control information and system information to a controller/processor 180. A channel processor may determine reference signal received power (RSRP), received signal strength indicator (RSSI), reference signal received quality (RSRQ), channel quality indicator (CQI), and/or the like.

On the uplink, at UE 104, a transmit processor 164 may receive and process data from a data source 162 and control information (e.g., for reports comprising RSRP, RSSI, RSRQ, CQI, and/or the like) from controller/processor 180. Transmit processor 164 may also generate reference symbols for one or more reference signals (e.g., based at least in part on a beta value or a set of beta values associated with the one or more reference signals). The symbols from transmit processor 164 may be precoded by a TX-MIMO processor 166 if application, further processed by modulators 154a through 154r (e.g., for DFT-s-OFDM, CP-OFDM, and/or the like), and transmitted to base station 102. At base station 102, the uplink signals from UE 104 and other UEs may be received by antennas 134a through 134t, processed by demodulators 132a through 1321, detected by a MIMO detector 136 if applicable, and further processed by a receive processor 138 to obtain decoded data and control information sent by UE 104. Receive processor 138 may provide the decoded data to a data sink 139 and the decoded control information to controller (e.g., processor) 140. Base station 102 may include communication unit 144 and communicate to a network controller 131 via communication unit 144. Network controller 131 may include communication unit 194, controller/processor 190, and memory 192. In some aspects, one or more components of UE 104 may be included in a housing. Memories 142 and 182 may store data and program codes for the base station 102 and the UE 104, respectively. A scheduler 146 may schedule UEs for data transmission on the downlink, uplink, and/or sidelink.

### Data Network Connectivity Using Satellite Constellations

As noted previously, low-orbit satellite constellation systems have been rapidly developed and deployed to provide wireless communications and data network connectivity. A fleet of discrete satellites (also referred to as “birds”) can be arranged as a global satellite constellation that provides at least periodic or intermittent coverage to a large portion of the Earth's surface. In many cases, at least certain areas of the Earth's service may have continuous or near-continuous coverage from at least one bird of the satellite constellation. For instance, a global satellite constellation can be formed based on a stable (and therefore predictable) space geometric configuration, in which the fleet of birds maintain fixed space-time relationships with one another. A satellite constellation be used to provide data network connectivity to ground-based devices and/or other terrestrial receivers. For example, a satellite constellation can be integrated with or otherwise provide connectivity to one or more terrestrial (e.g., on-ground) data networks, such as the internet, a 4G/LTE network, and/or a 5G/NR network, among various others. In one illustrative example, a satellite internet constellation system can include a plurality of discrete satellites arranged in a low-earth orbit and used to provide data network connectivity to the internet.

To implement an internet satellite constellation, the discrete satellites can be used as space-based communication nodes that couple terrestrial devices to terrestrial internet gateways. The terrestrial internet gateways may also be referred to as ground stations, and are used to provide connectivity to the internet backbone. For instance, a given satellite can provide a first communication link to a terrestrial device and a second communication link to a ground station that is connected to an internet service provider (ISP). The terrestrial device can transmit data and/or data requests to the satellite over the first communication link, with the satellite subsequently forwarding the transmission to the ground station internet gateway (from which point onward the transmission from the device is handled as a normal internet transmission). The terrestrial device can receive data and/or requests using the reverse process, in which the satellite receives a transmission from the ground station internet gateway via the second communication link and then forwards the transmission to the terrestrial device using the first communication link.

Although an internet satellite constellation includes a fleet of discrete satellites, it is often the case that terrestrial devices communicating with a satellite can only be connected to a ground station/internet gateway that is also able to communicate with the same satellite. In other words, it is typically the case that the first and second communication links described above must be established with the same satellite of the satellite constellation. A user connecting to any particular satellite is therefore limited by the ground station/internet gateways that are visible to that particular satellite. For instance, a user connected to a satellite that is unable to establish a communication link with a ground station/internet gateway is therefore unable to connect to the internet—although the fleet of satellites is a global network in terms of spatial diversity and arrangement, the individual satellites function as standalone internet relay nodes unless an inter-satellite link capability is provided.

In some cases, inter-satellite links can allow point to point communications between the individual satellites included in a satellite constellation. For instance, data can travel at the speed of light from one satellite to another, resulting in a fully interconnected global mesh network that allows access to the internet as long as the terrestrial device can establish communication with at least one satellite of the satellite internet constellation. In one illustrative example, a satellite internet constellation can implement inter-satellite links as optical communication links. For example, optical space lasers can be used to implement optical intersatellite links (ISLs) between some (or all) of the individual birds of a satellite constellation. In this manner, the satellite internet constellation can be used to transmit data without the use of local ground stations, and may be seen to provide truly global coverage.

For instance, optical laser links between individual satellites in a satellite constellation can reduce long-distance latency by as much as 50%. Additionally, optical laser links (e.g., ISLs) can enable the more efficient sharing of capacity by utilizing the otherwise wasted satellite capacity over regions without ground station internet gateways. Moreover, optical laser links allow the satellite constellation to provide internet service (or other data network connectivity) to areas where ground stations are not present and/or are impossible to install.

To implement a satellite constellation, one or more satellites may be integrated with the terrestrial infrastructure of a wireless communication system. In general, satellites may refer to Low Earth Orbit (LEO) devices, Medium Earth Orbit (MEO) devices, Geostationary Earth Orbit (GEO) devices, and/or Highly Elliptical Orbit (HEO) devices. In some aspects, a satellite constellation can be included in or used to implement a non-terrestrial network (NTN). A non-terrestrial network (NTN) may refer to a network, or a segment of a network, that uses an airborne or spaceborne vehicle for transmission. For instance, spaceborne vehicles can refer to various ones of the satellites described above. An airborne vehicle may refer to High Altitude Platforms (HAPs) including Unmanned Aircraft Systems (UAS). An NTN may be configured to help to provide wireless communication in un-served or underserved areas to upgrade the performance of terrestrial networks. For example, a communication satellite (e.g., of a satellite constellation) may provide coverage to a larger geographic region than a terrestrial network base station. The NTN may also reinforce service reliability by providing service continuity for UEs or for moving platforms (e.g., passenger vehicles-aircraft, ships, high speed trains, buses). The NTN may also increase service availability, including critical communications. The NTN may also enable network scalability through the provision of efficient multicast/broadcast resources for data delivery towards the network edges or even directly to the user equipment.

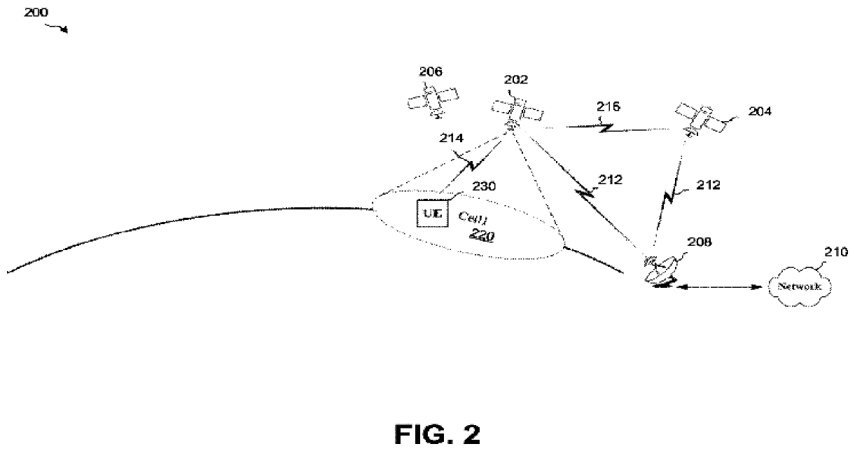

FIG. 2 is a diagram illustrating an example configuration 200 of an NTN for providing data network connectivity to terrestrial (ground-based) devices. In one illustrative example, the NTN can be a satellite internet constellation, although various other NTN's and/or satellite constellation data network connectivity types may also be utilized without departing from the scope of the present disclosure. As used herein, the terms “NTN” and “satellite constellation” may be used interchangeably.

An NTN may refer to a network, or a segment of a network, that uses RF resources on-board an NTN platform. The NTN platform may refer to a spaceborne vehicle or an airborne vehicle. Spaceborne vehicles include communication satellites that may be classified based on their orbits. For example, a communication satellite may include a GEO device that appears stationary with respect to the Earth. As such, a single GEO device may provide coverage to a geographic coverage area. In other examples, a communication satellite may include a non-GEO device, such as an LEO device, an MEO device, or an HEO device. Non-GEO devices do not appear stationary with respect to the Earth. As such, a satellite constellation (e.g., one or more satellites) may be configured to provide coverage to the geographic coverage area. An airborne vehicle may refer to a system encompassing Tethered UAS (TUA), Lighter Than Air UAS (LTA), Heavier Than Air UAS (HTA) (e.g., in altitudes typically between 8 and 50 km including High Altitude Platforms (HAPs)).

A satellite constellation can include a plurality of satellites, such as the satellites 202, 204, and 206 depicted in FIG. 2. The plurality of satellites can include satellites that are the same as one another and/or can include satellites that are different from one another. A terrestrial gateway 208 can be used to provide data connectivity to a data network 210. For instance, the terrestrial gateway 208 can be a ground station (e.g., internet gateway) for providing data connectivity to the internet. Also depicted in FIG. 2 is a UE 230 located on the surface of the earth, within a cell coverage area of the first satellite 202. In some aspects, the UE 230 can include various devices capable of connecting to the NTN 200 and/or the satellite constellation thereof for wireless communication.

The gateway 208 may be included in one or more terrestrial gateways that are used to connect the NTN 200 and/or satellite constellation thereof to a public data network such as the internet. In some examples, the gateway 208 may support functions to forward a signal from the satellite constellation to a Uu interface, such as an NR-Uu interface. In other examples, the gateway 208 may provide a transport network layer node, and may support various transport protocols, such as those associated with providing an IP router functionality. A satellite radio interface (SRI) may provide IP trunk connections between the gateway 208 and various satellites (e.g., satellites 202-206) to transport NG or F1 interfaces, respectively.

Satellites within the satellite constellation that are within connection range of the gateway 208 (e.g., within line-of-sight of, etc.) may be fed by the gateway 208. The individual satellites of the satellite constellation can be deployed across a satellite-targeted coverage area, which can correspond to regional, continental, or even global coverage. The satellites of the satellite constellation may be served successively by one or more gateways at a time. The NTN 200 associated with the satellite constellation can be configured to provide service and feeder link continuity between the successive serving gateways 208 with time duration to perform mobility anchoring and handover.

In one illustrative example, the first satellite 202 may communicate with the data network 210 (e.g., the internet) through a feeder link 212 established between the first satellite 202 and the gateway 208. The feeder link 212 can be used to provide bidirectional communications between the first satellite 202 and the internet backbone coupled to or otherwise provided by gateway 208. The first satellite 202 can communicate with the UE 230 using a service link 214 established within the cell coverage (e.g., field-of-view) area of an NTN cell 220. The NTN cell 220 corresponds to the first satellite 202. In particular, the first satellite 202 and/or service link 214 can be used to communicate with various different devices or UEs that are located within the corresponding NTN cell 220 of first satellite 202.

More generally, a feeder link (such as feeder link 212) may refer to a wireless link between a gateway and a particular satellite of a satellite constellation. A service link (such as service link 214) may refer to a wireless link between a UE and particular satellite of a satellite constellation. In some examples, one or more (or all) of the satellites of a satellite constellation can use one or more directional beams (e.g., beamforming) to communicate with the UE 230 via service link 214 and/or to communicate with the ground station/internet gateway 208 via feeder link 212. For instance, the first satellite 202 may use directional beams (beamforming) to communicate with UE 230 via service link 214 and/or to communicate with gateway 208 via feeder link 212. A beam may refer to a wireless communication beam generated by an antenna on-board a satellite.

In some examples, the UE 230 may communicate with the first satellite 202 via the service link 214, as described above. Rather than the first satellite 202 then using the feeder link 212 to forward the UE communications to internet gateway 208, the first satellite 202 may instead relay the communication to second satellite 204 through an inter-satellite link (ISL) 216. The second satellite 204 can subsequently communicate with the data network 210 (e.g., internet) through a feeder link 212 established between the second satellite 204 and the internet gateway 208. In some aspects, the ISL links can be provided between a constellation of satellites and may involve the use of transparent payloads on-board the satellites. The ISL link may operate in an RF frequency or an optical band. In one illustrative example, the ISL links between satellites of a satellite constellation can be implemented as optical laser links (e.g., using optical space laser transceivers provided on the satellites), as was noted previously above.

In the illustrated example of FIG. 2, the first satellite 202 may provide the NTN cell 220 with a first physical cell ID (PCI). In some examples, a constellation of satellites may provide coverage to the NTN cell 220. For example, the first satellite 202 may include a non-GEO device that does not appear stationary with respect to the Earth. For instance, the first satellite 202 can be a low-earth orbit (LEO) satellite included in a LEO satellite constellation for providing data network connectivity. As such, a satellite constellation (e.g., one or more satellites) may be configured to provide coverage to the NTN cell 220. For example, the first satellite 202, second satellite 204, and third satellite 206 may be part of a satellite constellation that provides coverage to the NTN cell 220.

In some examples, satellite constellation deployment may provide different services based on the type of payload onboard the satellite(s). The type of payload may determine whether the satellite acts as a relay node or a base station. For example, a transparent payload is associated with the satellite acting as a relay node, while a non-transparent payload is associated with the satellite acting as a base station. A transparent payload may implement frequency conversion and a radio frequency (RF) amplifier in both uplink (UL) and downlink (DL) directions and may correspond to an analog RF repeater. A transparent payload, for example, may receive UL signals from all served UEs and may redirect the combined signals DL to an earth station (e.g., internet gateway 208) without demodulating or decoding the signals. Similarly, a transparent payload may receive an UL signal from an earth station and redirect the signal DL to served UEs without demodulating or decoding the signal. However, the transparent payload may frequency convert received signals and may amplify and/or filter received signals before transmitting the signals.

A non-transparent payload may receive UL signals and demodulate or decode the UL signal before generating a DL signal. For instance, the first satellite 202 may receive UL signals from one or more served UEs (e.g., within the cell 220) and subsequently demodulate or decode the UL signals prior to generating one or more corresponding DL signals to the internet gateway 208. Similarly, the first satellite 202 may receive UL signals from the internet gateway 208 and subsequently demodulate or decode the UL signals prior to generating one or more corresponding DL signals to the served UEs within cell 220.

### Satellite Internet Constellations

A satellite internet constellation is a fleet of satellite internet constellation satellites (also referred to as “birds”) arranged in a low-earth orbit (LEO). Satellite internet constellations can be implemented based on the idea that, with a sufficiently large constellation, at any given time at least one satellite should be sufficiently close to communicate with both a user satellite dish and a satellite dish at an internet gateway. In such implementations, the internet gateway satellite dish is typically located in the same general vicinity (e.g., geographic area) as the user satellite dish because, as noted previously above, the same satellite is used to communicate with both the internet gateway and the user. Based on the same satellite communicating with both the user and the internet gateway, the satellite can be used to route (e.g., relay) internet traffic between the customer and the internet via the internet gateway.

Advantageously, users of such satellite internet constellations can connect to the internet without the requirement of having a physical connection to the internet gateway. For instance, internet users are typically connected to an internet gateway via a series of intermediate connections (also referred to as hops). In many cases, the direct physical connections between internet users and internet gateways are provided via internet service providers (ISPs), for example over fiber optic cables or copper lines. Satellite internet constellations (and the associated satellite internet service thereof) can be valuable for users for whom direct physical connections to an internet gateway are unavailable or otherwise prohibitively expensive. For instance, users in rural or low density areas may not have access to the internet and/or may not have access to high-speed (e.g., fiber) internet because the cost of a ground-based physical connection to a gateway cannot be amortized over a sufficiently large quantity of users to justify the expense (e.g., as physical internet infrastructure is often built out by ISPs with the expectation of recouping the buildout cost via monthly internet service fees charged to its customers).

Satellite internet constellations can provide internet access to both users who are adequately served by conventional/existing physical ground-based internet connections and to users who are not adequately served (if served at all) by the existing physical ground-based internet connections. In some cases, geographic considerations beyond population density can also be an impediment to providing ground-based internet connectivity. For instance, countries such as Indonesia are densely populated but have a landmass that is spread across numerous islands—in this case, it is logistically challenging and financially cumbersome to run fiber connections to all of the islands. Accordingly, geographic considerations can also act as a barrier to internet access when using conventional ground-based physical connections between users and internet gateways.

However, satellite internet constellations are not subject to the same geographic constraints as ground-based internet connections and, moreover, can often be financially justified based on the ability to amortize the higher capital costs across a significantly larger number of users (e.g., given that satellite internet constellations can provide multi-national or global coverage, based on the individual satellites completing multiple earth orbits per day). In the example of countries such as Indonesia, the separate islands are sufficiently proximate to one another so as to share a relatively small quantity of common satellite internet constellation internet gateways—in which case fiber connections would only need to be built and maintained to connect the gateways to the internet/internet backbone, as satellite links would be able to connect individual users on various islands to at least one of the gateways.

However, many existing satellite internet constellation approaches may be unable (or unsuitable) to provide satellite internet connectivity to users who are highly isolated from nearby terrestrial internet gateways (e.g., such as passengers onboard airplanes or boats in the open ocean). In this case, such users may have connectivity to one or more birds of the constellation, but there are no nearby terrestrial internet gateways to which the birds may route an internet connection for these users (e.g., the likelihood of an island with sufficient internet connectivity being sufficiently nearby so as to see the same satellite internet constellation bird as the plane/boat passengers is typically very low).

In addition to issues of connectivity that arise from the conventional requirement that the same bird of a satellite internet constellation be in sight of a user and a terrestrial internet gateway in order to provide internet connectivity to the user, existing satellite internet constellation approaches can also suffer from issues of latency.

### Internet Data Connectivity and Latency

The core protocol of the world wide web is the Hypertext Transfer Protocol (HTTP). In particular, HTTP is an application layer protocol in the internet protocol model. HTTP functionality is typically based on an HTTP client (usually a web browser, also referred to as a web client) opening a secure TCP/IP connection to an HTTP server (e.g., a web server) and sending an HTTP request for a particular webpage, usually of the form “GET/some/page.html” with various other metadata in the form of MIME headers (Multipurpose Internet Mail Extensions). The web server receives the HTTP request, performs computation(s) associated with the request, and replies to the client with a status code (usually of the form “200 OK” followed by MIME headers followed by the body of the HTTP response).

If the response is HTML (Hypertext Markup Language), then the HTML response will include references to other content that is needed to render the page requested by the client, for instance other HTML, JavaScript, images, videos, etc. These references take the form of unique URLs (Uniform Resource Locators, more commonly referred to as links) associated with each piece of content. The content needed to render the requested page can be hosted on the same web server as the requested page itself and/or can be hosted on one or more external servers. If the response from the web server includes URLs that refer to content hosted on the same web server, then the client can use the existing connection to request this additional content. For URLs that refer to content hosted on different/external servers, then the web client will subsequently open connections to each of these sources and make HTTP requests to them as well.

The minimum time required to render a web page is the time required for all of the aforementioned round trips between the web client and the various web servers to be completed. For instance, assuming that all of the content needed to render a web page is hosted on the same web server, then the minimum time required to render the web page is based on performing:
1× TCP/IP round trip to establish the connection between the web client and the web server (e.g., TCP handshake using SYN, SYN/ACK messages)
2× TLS (Transport Layer Security) round trips to secure the connection by exchanging cryptographic key/certificate information between the client and the server.
1× HTTP round trip to get the web page (e.g., HTML.)
1× HTTP round trip to get the content (e.g., images, video, etc.) on the web page

As such, a 5× core round trip time between the web client and the web server represents the best case scenario of the minimum time required to render a web page, assuming that all of the packets are delivered and assuming that the HTML and the content are both only one packet large. The minimum time required to render a web page can quickly grow as the above assumptions are loosened, and brought closer into line with reality. For instance, if the HTML and the content are both larger than one packet, then the minimum web page rendering time grows by the additional amount of time required to send the HTML and the content with respect to the bandwidth of the connection. Accounting for the risk/probability that packets will be dropped while they are sent adds additional time as well, as dropped packets require additional TCP round trips between the client and the server to retrieve (resend) the dropped packets. In reality, at least one additional round trip is added between the client and a domain name server (DNS), which is needed to resolve alphanumeric domain names (e.g., URLs) to corresponding IP addresses.

All round trip times (RTTs) are not equal, as any given RTT may be highly dependent on the network topography underlying the connection. Latency is the time it takes for data packets to pass from one point on a network to another, and each the RTT between a client and a server is equal to double the amount of latency. In particular, the number of different routers that packets must traverse between source and endpoint can vary based on a variety of different factors. Each router traversed by a packet is referred to as a “hop.” In relatively low-traffic conditions, the time between individual hops may generally be on the order of 10 s of milliseconds. However, each RTT associated with the minimum web page rendering time can quickly grow as the time between each hop increases (such as in higher-traffic conditions) and as the total number of hops per RTT increases.

Various approaches can be used to reduce internet latency. For example, one approach to reducing latency is based on using client-side caching web proxies, which are often installed by ISPs to lower costs and increase performance. Client-side caching web proxies maintain local copies of frequently accessed content, thereby avoiding at least some RTTs that would otherwise be needed to get the locally stored content from an external web server (e.g., as was described above). For instance, users can configure their browsers to access the internet through these proxy servers when using the ISP. However, one difficulty associated with client-side caching web proxies is properly determining which content to cache-users typically access a sufficiently wide array of content that it becomes difficult or impossible to determine what to cache.

Another approach to reducing latency is based on using CDNs (Content Delivery Networks). CDN's reduce latency by maintaining what are effectively server-side proxies of their customers' websites at network locations that are highly proximate (near) to multiple different ISPs. As such, when various web clients request a particular web page or piece of content that is hosted on the CDN (because the web page/content owner is a customer of the CDN), at least one CDN node should be closer to the web client than the actual server that hosts the web page or content. Accordingly, CDNs can provide an appreciably lower RTT between a web client and a server hosting requested content—and therefore, can provide an appreciably faster web page rendering time. If some of the latency experienced in the absence of a CDN is related to load or bandwidth capacity of the core web server, pushing the service out to a copy hosted on a CDN can reduce that latency as well.

In one illustrative example, customers of a CDN (e.g., web page operators) can use the CDN's domain name servers (DNSs) to return IP addresses for the proxies that the CDN determines or estimates are the closest to the client submitting the DNS request. In a simple CDN implementation, these proxies contain copies of the static content of the web page and must communicate back to the actual web server (e.g., core web server) to retrieve any dynamic content that requires access to real-time server information and/or is personalized for individual end users (e.g., personalized based on user data stored in a database associated with the web page. In the simple CDN implementation, the static content proxies must also communicate back to the core web server in order to send any updates from the web client to the web page's database. Current CDNs have advanced to be able to provide more complex computational and database services, for example based on predictive approaches to determining what content to cache and where the cached content should be stored/made available.

A major cost of existing CDNs, which operate on the principle of reducing internet latency by providing proxy copies of web content nearer to requesting web clients, is in providing sufficient proxy services at a sufficient number of locations so as to be appreciably more performant for the requesting web clients. Accordingly, existing CDN implementations typically require forward deployment of server hardware at a large number of locations. In particular, conventional CDNs forward deploy and scale in relatively expensive data centers that are located in close proximity to requesting web clients (both in terms of physical proximity and network topology proximity, i.e., latency/RTT/number of hops). The costs at each forward deployed CDN location can include the rental of physical space in a local data center; the purchase of hardware sufficient to serve the local users (requesting web clients); installation and maintenance of the hardware; power and cooling to operate the hardware; data costs for low-hop internet connectivity from the CDN to the users; data costs for connections to web servers (e.g., when providing access to small portions of large archives that update regularly); etc. These CDN implementation and operation costs must be amortized over a sufficiently large number of users to justify the buildout of the CDN-accordingly, CDN services can be expensive to customers (e.g., web page operators) and can be challenging for the CDN operator to determine the optimal mix of locations and hardware deployments that are optimal.

### Satellite Internet Constellation and Latency

While the use of LEO satellite internet constellations can mitigate the issue of latency as compared to GEO satellite internet (e.g., ˜20 ms RTT vs. ˜700 ms RTT), additional issues of latency may still persist due to issues of network topology outside of the feeder links and service links that a satellite internet constellation bird uses to route internet traffic between UEs and terrestrial internet gateways (e.g., as depicted in FIG. 2).

In particular, satellite internet constellations often utilize internet gateways (such as the terrestrial internet gateway 208 of FIG. 2) that are a relatively large number of hops away from the various websites and/or CDN proxies that users of a satellite internet constellation want to access. As such, satellite internet constellation users can experience latency that arises from the ground-based network topology connecting the terrestrial internet gateways to the rest of the internet.

In some cases, a satellite internet constellation provider may reduce latency by installing client-side proxies (e.g., client-side web caching proxies) in some, or all, of the terrestrial internet gateways utilized by the satellite internet constellation. A satellite internet constellation provider may additionally, or alternatively, utilize one or more CDNs to install server-side proxies, as was described above. However, client-side proxies and server-side proxies (e.g., CDNs) can be expensive to install and maintain, particularly given the relatively low quantity of users per terrestrial gateway—for instance, the number of users per terrestrial gateway may be too low to recoup all of the fixed costs associated with providing a client-side proxy or a server-side proxy.

Accordingly, there is a need for systems and techniques that can be used to more efficiently reduce the latency associated with satellite internet constellations. For instance, there is a need for systems and techniques that can be used to provide terrestrial user connectivity to a satellite internet constellation more efficiently and with lower latency. There is also a need to provide satellite internet constellation connectivity to CDN's and/or other proxies using fewer hops.

Aspects of the present disclosure can be used to provide lower latency satellite internet constellation data network connectivity. For instance, latency can be reduced between a client-side and the satellite internet constellation based on providing a plurality of ground-based satellite internet constellation dishes arranged about various geographic locations. In some examples, one or more rings (e.g., concentric rings) of ground-based satellite dishes can be arranged and interconnected to maximize and/or optimize the utilization of available bandwidth between the satellites of the constellation and ground-based users of the satellite internet constellation.

Latency can also be reduced between a server-side and the satellite internet constellation based on providing a plurality of ground-based satellite internet constellation dishes arranged about various data center and/or CDN locations. In some cases, the plurality of satellite dishes arranged about data centers or CDNs can be the same as or similar to the plurality of satellite dishes arranged about client-side UEs or users. For instance, same or similar polygonal arrangements of one or more rings (e.g., concentric rings) can be used to provide client-side links to the satellite internet constellation and can be used to provide server-side links to the satellite internet constellation, as will be described in greater depth below.

In another example, overall internet latency associated with the satellite internet constellation can be reduced by using the satellite internet constellation to route internet traffic between the client-side users and the server-side data centers/CDNs. For instance, based on a satellite constellation that utilizes optical space lasers or other inter-satellite links (ISLs), low latency satellite internet can be provided without the requirement that the same bird be used to connect a client-side user to a terrestrial internet gateway.

In some embodiments, polygon layers of satellite dishes can be provided at the periphery of relatively high urban density areas (e.g., as the periphery of such areas is lower-density) and may be interconnected to satellite dishes within the high-density areas, thereby increasing the total available satellite internet constellation bandwidth to the area. For example, the polygon layers of satellite dishes can be provided as star-shaped layers, or various other polygonal shapes configured to optimize the use of the satellite internet constellation and/or the available bandwidth thereof. For instance, the polygon layers of satellite dishes described herein can optimize the use (e.g., utilization) of satellite capacity by enabling the connected devices associated with the polygon layers of satellite dishes to reach a greater quantity of birds. In other words, a user or connected device of the satellite internet constellation can reach a greater percentage of the satellite constellation via the polygon layers of satellite dishes than would otherwise be possible via conventional approaches. Moreover, the polygon layers of satellite dishes can be seen to lower the intensity of satellite and/or ground radio signals in the surrounding area proximate to the polygon layers of dishes—for example, polygon layers of satellite dishes can operate with a lower signal intensity (e.g., signal power) as compared to a single dish or lesser quantity of dishes, advantageously permitting the polygon layers of satellite dishes to lessen or minimize interference near data center locations and/or to operate in urban areas with power levels that are below regulator thresholds.

In some embodiments, the ground-based satellite dishes can be interconnected wirelessly (e.g., microwave relay or various other RF communication methods) and/or can be interconnected with physical wired connections (e.g., fiber, etc.). Satellite internet constellation bandwidth may be a function of bandwidth per unit of land area. By increasing the total land area with satellite dishes for communicating with the satellite internet constellation, the total bandwidth to the satellite internet constellation is increased. By interconnecting the plurality of satellite dishes (e.g., interconnecting the dishes within each layer and/or interconnecting the different layers of dishes), this increased quantity of bandwidth can be combined and provided to the high-density urban area, far in excess of the bandwidth that would otherwise be obtainable using non-interconnect satellite dishes installed within the urban area/directly at the point of use.

In another illustrative example, latency can be reduced between the server-side and the satellite internet constellation based on implementing a satellite internet constellation Content Delivery Network (CDN). For instance, a plurality of ground-based satellite internet constellation dishes can be arranged in proximity to servers or data centers that host web pages and content accessed by users of the satellite internet constellation. In some embodiments, the plurality of ground-based satellite dishes can be arranged in proximity to (and communicatively coupled with) existing CDNs, and utilized to provide users of the satellite internet constellation with lower latency (e.g., fewer hops) connections to the CDNs. For instance, as will be described in greater depth below, one or more rings of ground-based satellite dishes can be provided around data origin servers (e.g., web pages, content, APIs, etc.). The data origin servers can be accessed, via the satellite internet constellation, by users having their own satellite internet terminals or ground-based satellite dish. The data origin servers can additionally be accessed by users in areas that are surrounded with one or more rings of ground-based satellite dishes, such as urban areas or other high-density areas. In such embodiments, the operator(s) of the data origin servers can use the satellite internet constellation to more efficiently and effectively provide requested content to users. For instance, rather than having to pay for a local version of the content to be hosted in each urban center (either directly or via a conventional CDN service provider), the data origin servers can communicate directly with the satellite constellation via the ring(s) of satellite dishes arranged around the data origin servers. Notably, it can be more cost effective to provide these rings of satellite dishes local to users/clusters of users and maintain the content of the data origin servers at host locations where it is cheapest to do so, using the satellite internet constellation to then interconnect the two terrestrial locations/connection endpoints.

As such, the systems and techniques described herein can be used to reduce the number of hops between users of a satellite internet constellation and any existing CDN or website data center, based on providing ground-based satellite dishes directly coupled to the existing CDNs and website data centers. In this example, traffic from the birds of the satellite internet constellation can reach the existing CDN's or website data centers in a fewer number of hops (relative to having to traverse the ground-based internet) by being transmitted directly to a ground-based satellite dish that is local to the data origin server.

In some examples, the systems and techniques described herein can additionally, or alternatively, be utilized with distributed CDN and/or data center infrastructure (e.g., as opposed to existing, highly centralized CDN or data center infrastructure). For example, rather than providing concentrated or highly consolidated server-side proxy infrastructure (as is the case with traditional CDNs), the satellite internet constellation CDN described herein can be distributed across a greater number of data center locations. Additionally, the satellite internet constellation CDN can be implemented in a more localized (and/or hyper-localized) fashion, such that server-side content does not need to be forward-deployed at one of only a few, concentrated CDN locations. For instance, the satellite internet constellation CDN described herein can be used in combination with data centers that are located in more remote areas and/or data centers that are distributed across a wider geographic region (both of which can be seen to reduce the cost associated with running the data center). By providing one or more ground-based satellite internet constellation dishes at or near the location of the various data centers (e.g., in the form of one or more rings of satellite dishes around the data origin server locations), the systems and techniques can be used to reach each data origin server more directly as compared to traversing the ground-based internet. Additionally, the systems and techniques can be used to implement a latency-reducing CDN based on reducing the number of hops between the localized CDNs/data centers and the satellite internet constellation birds, again as compared to traversing the ground-based internet.

These and other aspects of the disclosure are described in further detail below.

As noted previously, the popularity and prevalence of CDNs is largely based on the ability of CDNs to provide lower internet latency for their customers' websites. Legacy CDNs can achieve this latency reduction by forward deploying costly hardware into the physical and network locations that are close to the end users of the websites (e.g., the web clients that request content from the websites). These physical and network locations are often the most expensive locations for this CDN hardware to operate in, as the physical space for CDNs is often located in dense urban areas while the network location for CDNs is often provided by an ISP or dedicated internet peering provider.

In one illustrative example, the systems and techniques described herein can be used to more efficiently provide CDN-based latency reduction using satellite internet constellations with ISLs such as optical space lasers. For instance, it can be more cost effective to forward deploy and operate a plurality of satellite internet constellation dishes at locations that are sufficiently close to groups of users that are geographically proximate to one another and a plurality of satellite internet constellation dishes at locations that are sufficiently close to the servers or proxies they are using. As will be described in greater depth below, lower latency (e.g., relative to traversing all the hops of the ground-based internet connection between the users and the servers/proxies) can then be achieved by routing internet traffic through the lower cost user-local satellite internet constellation dishes, up to overhead birds of the constellation, and then across (e.g., via optical space laser or other ISLs) to different birds that are overhead the servers/proxies hosting the requested websites or content (e.g., and/or APIs, internet services, etc.). Accordingly, website operators can increase their capacity at a much lower cost as compared to conventional CDNs, for example by operating (e.g., hosting) their web content in a favored or preferred data center location that connects via a satellite internet constellation link, rather than using expensive, forward-deployed CDN hardware that connects via fiber or other ground-based connection means.

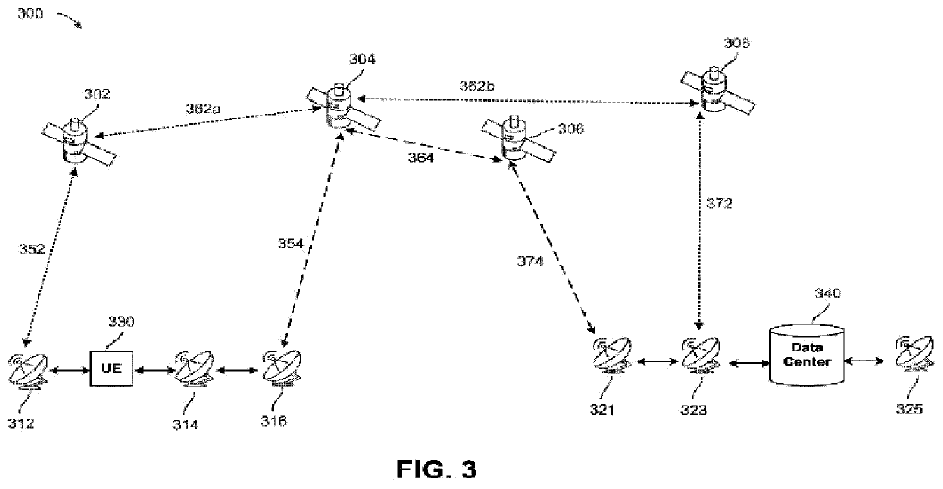

FIG. 3 is a diagram illustrating an example of a satellite internet constellation CDN 300, which in some aspects can be used to provide low latency satellite internet connectivity to a plurality of users. The plurality of users can be associated with a corresponding plurality of UEs, such as the UE 330 depicted in FIG. 3. The UE(s) 330 can include various different computing devices and/or networking devices. In some embodiments, the UEs 330 can include any electronic device capable of connecting to a data network such as the internet.

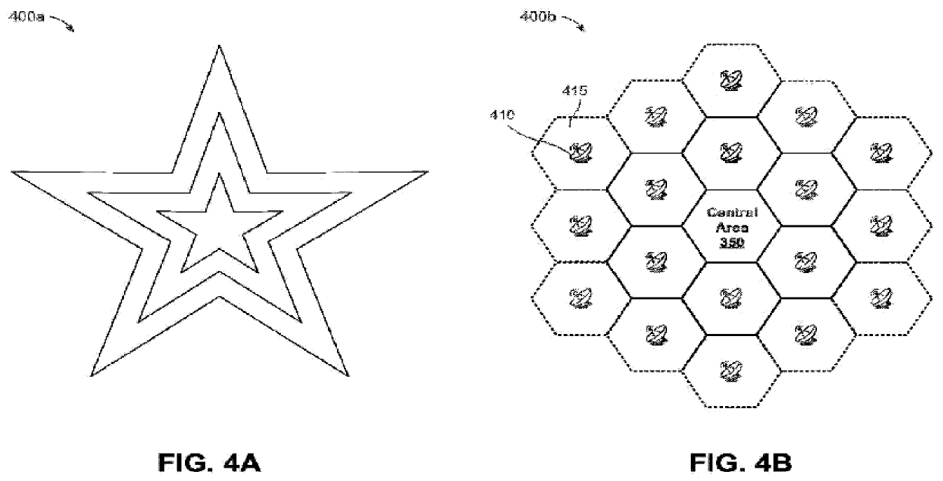

The UE 330 can be associated with a plurality of client-side satellite internet constellation dishes, shown here as the satellite dishes 312, 314, and 316, although it is noted that a greater or lesser quantity of satellite dishes can be used without departing from the scope of the disclosure. In one illustrative example, the UE 330 and the satellite dishes 312, 314, 316 can be associated with one another based on a common or proximate geographic location, area, region, etc. In other words, it is contemplated that a plurality of client-side satellite internet constellation dishes can be deployed to serve (e.g., provide connectivity to the satellite internet constellation) various different geographic areas, with various granularities as desired. For example, a group of satellite dishes can be deployed in and around a city, a town, a region, etc. The groups of satellite dishes can also be deployed in rural areas, i.e., lower-density concentrations of users. In general, it is contemplated that the groups of satellite dishes can be scaled up or down based on factors such as the quantity of users that are to be served, the land area or density of users to be served, the required bandwidth, etc. Additional details of the arrangement of the groups of satellite dishes will be described with respect to FIG. 4.

The client-side satellite dishes 312, 314, 316 can communicate with a satellite internet constellation, shown here as including a first satellite 302, a second satellite 304, a third satellite 306, and a fourth satellite 304. However, it is noted that a greater quantity of satellites can be used to implement the satellite internet constellation, with FIG. 3 presenting a simplified example for purposes of clarity of explanation.

Similarly, a plurality of server-side satellite internet constellation dishes 321, 323, 325 can be provided in association with various different gateways, such as the gateway 340 depicted in FIG. 3. In some embodiments, the gateway 340 can be an internet gateway that provides connectivity to an internet backbone. In some aspects, the gateway 340 can be a data center or CDN that caches, hosts, stores, serves, or otherwise provides web content in response to receiving corresponding client requests for the content. It is again noted that a greater or lesser quantity of server-side satellite dishes can be utilized without departing from the scope of the present disclosure. As was described above with respect to the client-side satellite dishes 312, 314, 316, the server-side satellite dishes 321, 323, 325 can be associated to a respective data center 340 based on a common or proximate geographic location, area, region, etc. In one illustrative example, the server-side satellite dishes 321, 323, 325 can be located at varying levels of proximity to the respective data center 340. For instance, an inner layer of server-side satellite dishes can include the satellite dishes 323 and 325, which may be provided at the closest physical distance to the data center 340. An outer layer of server-side satellite dishes can include at least the satellite dish 321, which is located at a greater distance away from the data center 340 relative to the inner layer dishes 323 and 325. In some embodiments, the outer layer satellite dishes can be communicatively coupled to the inner layer satellite dishes via a wired and/or wireless connection. For example, the outer layer server-side satellite dish 321 can be communicatively coupled to the inner layer server-side satellite dish 323 via a wireless microwave relay connection (among various other wireless/RF connections) and/or can be communicatively coupled to the inner layer server-side satellite dish 323 via a wired fiber connection.

By providing multiple different satellite dishes for communicating with the satellite internet constellation, at both the client-side associated with UE 330 and the server-side associated with datacenter 340, the systems and techniques described herein can increase the satellite constellation ground coverage area available to the UE 330 and to the datacenter 340. For instance, at the client-side associated with UE 330, the number of birds that are visible to or overhead the set of dishes 312, 314, 316 will almost always be greater than the number of birds that are visible to or otherwise overhead any individual one of the three client-side dishes 312, 314, 316. Similarly, at the server-side associated with datacenter 340, the number of birds that are visible to or otherwise overhead the set of the three dishes 321, 323, 325 will almost always be greater than the number of birds that are visible to or otherwise overhead any individual one of the three server-side dishes 321, 323, 325.

The interconnecting of the satellite dishes at each respective client location and at each respective server location, when combined with a satellite internet constellation implement optical space lasers or other ISLs, can enable more direct connectivity between the UE 330 and the datacenter 340. For instance, the UE 330 may use satellite dish 312 to communicate with satellite 302, via a service link 352. As illustrated, satellite 302 is out of range of the data center 340 (e.g., satellite 302 cannot establish a feeder link with any of the server-side dishes 321, 323, 325). In a conventional satellite internet constellation without ISLs, UE 330 would therefore be unable to use satellite 302 to obtain internet connectivity with data center 340 (based on the requirement in conventional satellite internet constellations that the same bird be used to connect the UE and an internet gateway).

Here, however, the UE 330 is able to establish internet connectivity with datacenter 340 via a first ISL 362a between satellite 302 and satellite 304, a second ISL 362b between satellite 304 and satellite 308, and a feeder link from satellite 308 to the server-side satellite dish 323. Notably, the UE 330 can establish internet connectivity with data center 340 via multiple different ISL-based paths through one different sets of birds of the satellite internet constellation. For instance, a first path from UE 330 to datacenter 340 is the combined path 352-362a-362b-372 described above. At least a second path from UE 330 to datacenter 340 may also be utilized. For example, the server-side dish 316 can communicate with satellite 304 via a service link 354, satellite 304 can communicate with satellite 306 via ISL 364, and satellite 306 can communicate with server-side dish 321 via feeder link 374.

Various other paths from the UE 330 to the datacenter 340 can also be utilized, with the two example paths of FIG. 3 provided for purposes of example and illustration, and not intended as limiting. For instance, the UE 330 can establish internet connectivity with datacenter 340 using a combination of: a particular service link selected from a plurality of available service links between one of the client-side dishes 312, 314, 316 to one of the birds of the constellation; one or more particular ISLs selected from a plurality of available ISLs between various combinations of two or more birds of the constellation; and a particular feeder link selected from a plurality of available feeder links between one of the birds of the constellation to one of the server-side dishes 321, 323, 325.

In some embodiments, the plurality of server-side satellite dishes (e.g., the dishes 321, 323, 325) can be located proximate to a datacenter, CDN, or other server-side proxy that serves internet content directly. In this example, the number of hops needed to provide internet connectivity to the UE 330 can be approximately equal to the 2+the number of ISLs in the path through the satellite constellation (e.g., 1× service link from UE 330 to the constellation, 1× feeder link from the constellation to the datacenter 340, and any ISLs taken between the service link satellite and the feeder link satellite).

In another example, the plurality of server-side satellite dishes (e.g., dishes 321, 323, 325) can be located proximate to a terrestrial internet gateway that connects via ground-based connections, such as fiber, to the corresponding datacenter, CDN, server-side proxy, etc., that hosts content requested by UE 330. For instance, one or more server-side satellite dishes can be provided proximate to multiple different terrestrial internet gateways. In this manner, the satellite internet constellation may, in some cases, analyze a client request from UE 330 to determine a particular terrestrial internet gateway that has the lowest latency to a proxy of the web server associated with the client request. Based on the analysis, the satellite internet constellation can determine one or more ISLs to route the client request to a bird that is overhead the identified gateway having the lowest latency to the proxy. In some examples, the satellite internet constellation can determine the lowest latency as the lowest latency from one of the terrestrial internet gateways to a proxy of the requested web server (e.g., without accounting for additional latency introduced by the number of ISLs or inter-satellite constellation hops needed to connect UE 330 to the lowest latency internet gateway). In other example, the satellite internet constellation can determine the lowest latency as being inclusive of both the latency through the ISL hops within the satellite constellation plus the latency through the one or more hops from a gateway to the proxy.

Notably, the systems and techniques described herein can be used to provide lower latency satellite internet by decoupling UE 330 from the limitation of only being able to connect to its local internet gateways. In some cases, the satellite internet constellation can receive signaling from one or more server-side proxies indicative of a current load, predicted load, etc., associated with each respective one of the server-side proxies. Based on the indicated load information for the proxies, the satellite internet constellation can more intelligently route internet traffic to gateways with proxies having sufficient capacity (and/or the most available capacity) to handle the traffic. For instance, the traffic-aware routing (e.g., load balancing) can be implemented in combination with the latency-based routing described above.

In some embodiments, the satellite internet constellation can be configured to inspect and/or analyze the contents of internet traffic from UE 330. For instance, if the satellite internet constellation is able to inspect the contents of client-side internet traffic, a web client (e.g., browser) and/or a satellite internet constellation client-side proxy can maintain a consistent/persistent secure connection with an appropriate gateway proxy, thereby reducing the number of roundtrips by approximately 60%. The roundtrip reduction of 60% may be in addition to the already reduced number of hops between the UE 330 and the datacenter 340.

As noted previously, it is contemplated that the systems and techniques described herein can be implemented across multiple different geographic areas, across various different population densities, across various different bandwidth needs, etc. In one illustrative example, a plurality of satellite dishes can be provided at client-side locations and at server-side locations, with the plurality of satellite dishes configured based at least in part on the density of the service area and the bandwidth requirements of the service area.

For instance, in existing approaches to satellite internet, the satellite internet constellation bandwidth per square meter can be far too small for every user in an urban center (or other high-density area) to be able to install and use their own client-side satellite dish functionally. In one illustrative example, a plurality of client-side satellite dishes (e.g., such as the client-side dishes 312, 314, 316 of FIG. 3) and/or a plurality of server-side satellite dishes (e.g., such as the server-side dishes 321, 323, 325 of FIG. 3) can be utilized to increase the total bandwidth available to a given client-side location or a given server-side location, respectively. For example, a plurality of satellite dishes for communicating with a satellite internet constellation can be provided at the periphery of a relatively high-density location, as land at the periphery is lower cost and lower-density space.

In one illustrative example, one or more layers or rings of satellite dishes can be installed at different distances (e.g., radii) from a central service area (e.g., city, urban area, relatively high-density areas, etc.) that utilizes the satellite dishes for connectivity to the satellite internet constellation. For instance, the one or more layers of satellite dishes can be provided as polygon layers each including a respective plurality of satellite dishes.

FIGS. 4A and 4B depict example satellite dish configurations that can be used to increase an available bandwidth to the satellite internet constellation, at either a client-side location, a server-side location, or both. In particular, the example satellite dish configurations described herein can increase bandwidth based on increasing a total quantity of available between the satellite dishes and the satellite constellation and/or based on increasing a total quantity of birds that are overhead the satellite dish array (e.g., and therefore available for connection).

In one illustrative example, the polygon layers of satellite dishes utilized at the client-side location(s) and/or the server-side location(s) can be implemented as star-shaped layers of satellite dishes, as depicted in the example of FIG. 4A. In this example, a satellite dish can be installed at some (or all) of the vertices of each star-shaped layer. For instance, FIG. 4A depicts an inner layer, a middle layer, and an outer layer of satellite dishes, although it is noted that a greater or lesser quantity of layers can also be utilized. In one example, a satellite dish can be provided at each vertex of each layer, in which case each respective star-shaped layer includes 10 satellite dishes. Various other arrangements are also possible for the constituent satellite dishes included in each respective layer. For instance, a satellite dish can be provided at each of the five outer vertices of each layer, but not at the five inner vertices; a satellite dish can be provided at each of the five inner vertices of each layer, but not at the five outer vertices; successive layers can alternate between providing satellite dishes at only the inner vertices and only the outer vertices; etc.

The polygon layers of satellite dishes can be centered around a central service area that will consume or utilize the satellite internet constellation connectivity and bandwidth provided by the polygon layers of satellite dishes. The central service area can be a client-side service area, can be a server-side service area, or various combinations of the two (e.g., the plurality of dishes included in the polygon layers can be used to provide service links between the constellation and UEs within the central service area, can be used to provide feeder links between the constellation and gateways/datacenters/CDNs within the central service area, or both).

In some embodiments, the quantity of satellite dishes provided in each polygon layer can be determined such that the plurality of satellite dishes across the total set of polygon layers saturates the maximum quantity of satellite constellation birds that may be overhead at any given time. In other words, the polygon layers can be arranged and populated with a quantity of satellite dishes that corresponds to the satellite internet constellation maximum density. Accordingly, the plurality of polygon layers of satellite dishes can be used to allow increasing numbers of users in high density locations to reach the satellite internet constellation, and therefore internet gateways (and/or CDNs, datacenters, proxies, etc.) that are distant from the high density user service area but are also connected to the satellite internet constellations (e.g., as described with respect to FIG. 3 above).

In one illustrative example, an innermost polygon layer of satellite dishes (e.g., the innermost star-shaped layer depicted in FIG. 4A) can be utilized to provide direct connectivity with various users and UEs that are located within the central service area of the multiple polygon layers. For example, the innermost layer of satellite dishes can communicate with the various users and UEs via wired and/or wireless connections.

Some, or all, of the outer polygon layers (e.g., all but the innermost layer) can be connected to the inner polygon layer. For example, the outer polygon layers can ground-connect to the inner polygon layer via fiber or other wired connection(s) and/or can connect to the inner polygon layer via point-to-point ground-based wireless connectivity, such as microwave or other RF relay technologies. In some embodiments, each satellite dish provided in a given outer polygon layer can be communicatively connected to at least one satellite dish of the inner polygon layer. For example, each satellite dish in each respective outer layer can be connected to the closest satellite dish of the inner layer.

In some examples, each outer layer of satellite dishes can be directly connected to at least one inner layer satellite dish. In another example, each layer of satellite dishes can be directly connected to at least one dish in the immediately adjacent layer. For instance, in the context of FIG. 4A, dishes located in the outermost star-shaped layer can connect to at least one dish in the middle star-shaped layer (e.g., can connect to the closest dish in the middle layer). Similarly, each dish located in the middle of the three star-shaped layers can connect to at least one dish in the inner star-shaped layer. In this case, the connections between the middle layer dishes and the inner layer dishes are responsible for forwarding traffic from both the middle layer and the outer layer to the inner layer dishes.

In some aspects, some (or all) of the respective satellite dishes included in a given polygon layer can be interconnected with one another (e.g., some or all of the plurality of dishes of the inner star-shaped layer can be interconnected with one another; some or all of the plurality of dishes of the outer star-shaped layer can be interconnected with one another; etc.). In this example, one or more of the outer layer dishes can indirectly connect to an inner layer dish via the interconnections within each of the outer layers. For example, a subset of outer layer dishes can be configured to aggregate traffic from other outer layer dishes (via the inter-layer connections between dishes) and then forward the outer layer traffic to the inner layer.

It is noted the various connectivity options described above can be bidirectional, such that traffic can flow from the outer layer dishes to the inner layer dishes (and then on to the client-side and/or server-side devices located within the coverage area of the plurality of polygon layers of satellite dishes), and can also flow from the inner layer dishes to the outer layer dishes.

FIG. 4B depicts another example configuration of a plurality of satellite dishes that can be arranged in rings or layers about a central service area 350. In this example, a plurality of satellite dishes 410 are shown, along with a corresponding coverage area 415 that may be associated with each of the satellite dishes 410. The coverage areas 415 are depicted as hexagonal in shape, although it is noted that this is for purposes of illustration, and various other coverage area sizes, shapes, geometries, etc., may also be utilized.

The plurality of satellite dishes 410 can be arranged about the central service area 450 such that the corresponding plurality of coverage areas 415 provide continuous coverage within the region enclosed by or otherwise associated with the plurality of satellite dishes 410. For instance, the hexagonal coverage areas 415 tessellate, and therefore can be used to provide continuous and/or overlapping coverage at any given location within the layers of satellite dishes. Here, a first layer or ring of satellite dishes can include the six satellite dishes 410 with corresponding coverage areas 415 that are immediately adjacent to the central service area 350 (e.g., the six satellite dishes that share an edge with the central service area 350). An outer layer or ring of satellite dishes can include the 12 satellite dishes 410 with corresponding coverage areas 415 that are immediately adjacent (e.g., share an edge with) one of the six inner layer satellite dishes. A greater or less quantity of satellite dish layers than the two layers depicted in FIG. 4B can be utilized without departing from the scope of the present disclosure. Connections can be provided between pairs of dishes that are located in different layers and/or connections can be provided between pairs of dishes that are located in the same layer (e.g., in a manner the same as or similar to that described above with respect to FIG. 4A).

### Vehicle-Based Satellite Internet Constellation Cloud Services

As noted previously, the systems and techniques described above can utilize one or more satellite internet constellations to provide data network connectivity between various client-side devices and various server-side devices. For instance, server-side devices (e.g., such as the data center 340 of FIG. 3) can be existing and/or conventional data center locations, which are often consolidated in only a handful of geographic areas that offer combined access to the requisite power and connectivity required for operating such data centers.

In one illustrative example, the satellite internet constellation data network connectivity described above can be seen to enable the use of mobile and/or modular data center apparatuses that can be deployed in a distributed fashion without the conventional dependency on existing internet (e.g., fiber) and power (e.g., relatively low cost grid electricity) infrastructure that is associated with conventional data centers.

In particular, described herein are systems and techniques for providing grid-independent edge computing, using a plurality of data center apparatuses (also referred to as “grid-independent units,” “modular compute units,” “mobile compute units,” and/or “edge compute units”) configured to utilize one or more satellite internet constellations for internet or other data network connectivity. In some aspects, the grid-independent edge computing units described herein can be used to implement distributed cloud computing infrastructure and/or distributed cloud computing services. Advantageously, as compared to legacy cloud services technology models, the grid-independent edge computing units disclosed herein are not subject to the same requirements or needs for power and connectivity at scale. For instance, grid-independent units can generate or otherwise obtain their own electrical power in a local and/or self-sufficient manner, rather than being reliant upon legacy point sources for electrical power distribution. Additionally, grid-independent units can include one or more satellite dishes or satellite transceivers for bidirectional communication with various birds of a satellite internet constellation, thereby capable of implementing internet connectivity across a wide variety of disparate geographic locations, rather than being reliant upon legacy point sources for internet connection and interconnection.

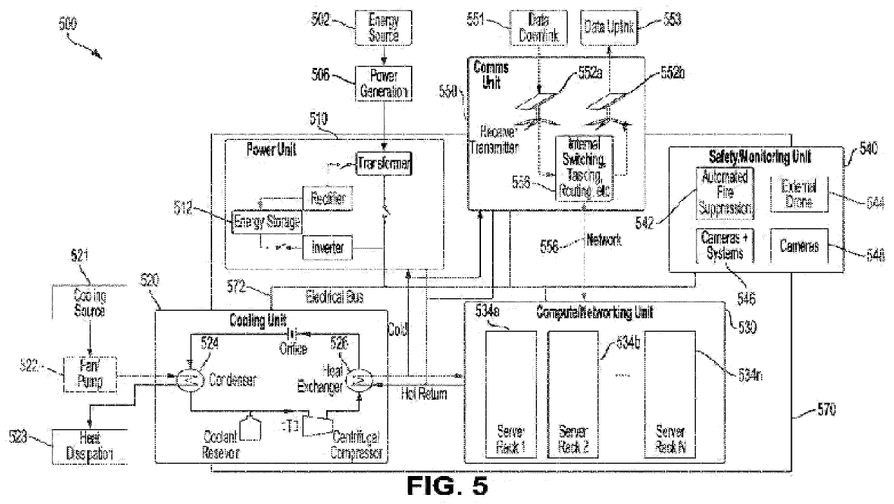

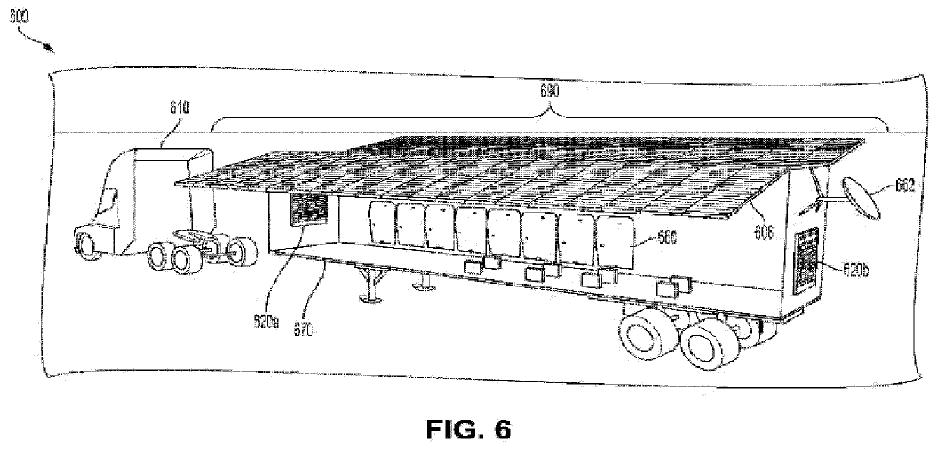

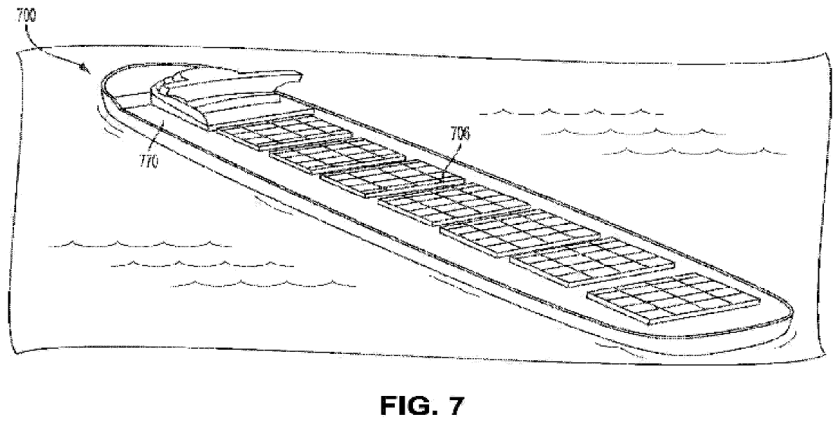

As will be described in greater depth below, the grid-independent compute units can be configured as edge compute units—utilizing onboard power sources and/or onboard power generation, in combination with satellite internet constellation connectivity, to push data and/or computational power to edge locations of the existing internet network topology. Notably, the grid-independent compute units can additionally be seen to expand or redefine the “edge” of the existing internet network topology or infrastructure, based on utilizing their onboard power generation and satellite internet constellation connectivity to provide data and computational power to geographic locations that were previously unconnected to the internet. An example architecture of a grid-independent compute unit will be described below with respect to FIG. 5, followed by example implementations of land-based and water-based implementations of a grid-independent compute unit (described below with reference to FIGS. 6 and 7, respectively).

In some aspects, the grid-independent compute units can be implemented in various form factors and modalities, including stationary, semi-stationary, and mobile or otherwise portable. Semi-stationary and mobile implementations of a grid-independent compute unit can be movable or otherwise transportable between different geographic locations. In some aspects, the grid-independent unit can include one or more locomotion systems (e.g., such as wheels, treads, rotors, etc.) such that the grid-independent unit is capable of providing its own propulsive force to move from one geographic location to another (and/or to reposition or reorient the grid-independent compute unit within its existing or current location). In some embodiments, the movement of self-propelled grid-independent compute unit can be controlled manually by a human operator, either locally, remotely, or a combination of the two. In some cases, the movement of a self-propelled grid-independent compute unit can be performed autonomously and/or semi-autonomously (e.g., utilizing one or more autonomous control systems running on the compute hardware of the grid-independent compute unit and/or running on dedicated navigation hardware also included in the grid-independent compute unit).

In some aspects, the grid-independent compute units can be terrestrial or land-based. For instance, a grid-independent compute unit can be implemented using a containerized housing, an example of which is described below with respect to FIG. 6. In some embodiments, the containerized housing of a grid-independent compute unit may have a same or similar form factor to a shipping container. A shipping container-based grid-independent compute unit can be self-propelled or partially self-propelled. In some aspects, a shipping container-based grid-independent compute unit can be towed using a tractor or other independent/external locomotion unit.

In some examples, the grid-independent compute units can be implemented as a marine or water-based form factor. For instance, a grid-independent compute unit can be implemented as a surface or sub-surface vessel, capable of navigating on and within various bodies of water. In some embodiments, a grid-independent compute unit can be implemented as a ship, boat, barge, etc., an example of which is described below with respect to FIG. 7.

These and further aspects of the presently disclosed grid-independent compute units will be described in greater detail below with reference to the figures.

### Grid-Independent Edge Computing Example Architecture

FIG. 5 is a block diagram illustrating an example architecture of a grid-independent edge computing device 500 with satellite constellation data network connectivity, in accordance with some examples. In some embodiments, the grid-independent edge computing device 500 can be implemented as a self-contained unit or system, for example enclosed within a housing 570. Housing 570 can be provided in various form factors, based on the planned deployment of the grid-independent edge computing device 500 (e.g., desired capabilities, expected geographic location(s), etc.). In one illustrative example, the housing 570 can be integrated with a vehicle or other propulsion system for transportation and movement of the grid-independent compute unit 500. In other examples, the housing 570 can be a standalone housing, which may be configured for removable coupling with external vehicles or other locomotion units for transportation and movement of the grid-independent compute unit 500 as needed.

In general, the housing 570 can include one or more energy generation units for providing electrical power without connection to an electric grid (e.g., grid-independent); one or more energy storage units for storing energy and powering the grid-independent compute unit 500 when the energy generation unit is insufficient or unavailable; one or more computational units, such as servers (or racks thereof); and one or more data storage units, such as hard disk drives (HDDs) and/or solid state drives (SSDs). The components included within or otherwise associated with housing 570 can be utilized to provide a standalone and self-sufficient (either wholly or partially) compute unit that can be used to implement distributed computational tasks, edge compute tasks, satellite internet CDN services, and/or satellite internet constellation cloud services, among various others.

As illustrated, the grid-independent compute unit 500 can include a power unit 510, a cooling unit 520, a compute/networking unit 530, a safety/monitoring unit 540, and a communication unit 550, each of which are described in turn below.

The power unit 510 can be used to provide and/or regulate electrical power to various components and modules included in the housing 570. In one illustrative example, the power unit 510 can be associated with one or more energy sources 502 from which one or more power generation modules 506 obtain (e.g., generate) electrical power. In some embodiments, the energy source(s) 502 can be located in a surrounding environment of the housing 570 (and therefore a surrounding environment of the grid-independent unit 500). For instance, the energy source(s) 502 can include various renewable energy sources which can include, but are not limited to, solar, wind, thermal, geothermal, tidal, etc.

The power generation module(s) 506 can each be associated with or otherwise correspond to one or more particular types of grid-independent energy. For instance, in one illustrative example, the power generation module 506 can correspond to the energy source 502. When the energy source 502 is solar energy, the power generation module 506 can comprise one or more solar panels or other photovoltaic (PV) power generation modules. When the energy source 502 comprises wind energy, the power generation module 506 can be provided as one or more wind turbines, fans, or other bladed rotors coupled to an electrical generator (which may itself be an electrical motor of the grid-independent compute unit 500, configured at least temporarily to be driven as a generator). In another example, when the energy source 502 comprises thermal energy, the power generation module 506 can provided as one or solar collectors, heat pumps, ground source heat pumps, etc. In another example, when the energy source comprises tidal energy, the power generation module 506 can be provided as one or more tidal energy collectors.

In some aspects, thermal energy may include the thermal energy of combustion, in which case the energy source 502 can be provided as a quantity or supply of various solid and/or liquid fuel sources (e.g., gasoline, diesel, kerosene, etc.) and the power generation module 506 can be provided as a corresponding combustion engine, turbine, etc., adapted for the particular fuel type of energy source 502.

In some embodiments, the grid-independent unit 500 can further include one or more backup or alternative energy sources (in addition to the primary energy source 502) and one or more corresponding backup power generation modules (in addition to the primary power generation module 506). In one illustrative example, the backup energy source and corresponding backup power generation module can be used to supplement or augment the power generated by the primary power generation module 506 (e.g., such as when the total power output of primary power generation module 506 is less than the load or power consumption associated with the operation of grid-independent unit 500). In another illustrative example, the backup energy source and corresponding backup power generation module can be used in place of the respective primary energy source 502 and primary power generation module 506. For instance, a backup diesel generator can use stored diesel fuel to generate electrical power during periods of time during which the primary energy source 502 is unavailable or insufficient. In some embodiments, the primary energy source 502 may be solar energy, and the backup diesel generator can be used to generate electrical power during the night, on cloudy days, and during various other environmental conditions that decrease or eliminate the availability of solar energy. In another example, the primary energy source 502 may be wind energy, and the backup diesel generator can be used to generate electrical power on calm days and during other periods of little to no wind activity. In some aspects, the backup energy source and backup power generation module can generate electrical power that is provided to the power unit 510 in the same or similar manner as the electrical power that is provided to the power unit 510 by the primary power generation module 506.

The power unit 510 can be used to transform, convert, condition, and/or otherwise prepare the electrical power generated by the power generation module 506 for distribution to and usage by the various other components of grid-independent edge compute unit 500. For instance, in some embodiments the power unit 510 can include one or more transformers for adjusting the voltage provided by power generation module 506 either up or down, as is appropriate; one or more rectifiers for converting alternating current (AC) into direct current (DC); one or more inverters for converting DC into AC; etc. In some aspects, the power unit 510 can further include one or more energy storage modules 512, which can be utilized to store electrical energy generated by the power generation module 506 (e.g., excess energy, above the instantaneous load drawn by the grid-independent unit 500). For instance, the power unit 510 can include one or more batteries (e.g., energy storage modules 512) that are charged by the power generation module 506 and discharged as needed to power (either in whole or in part) some, or all, of the various components of the grid-independent unit 500.

In some embodiments, a capacity of the energy storage module(s) 512 can be determined based at least in part on a maximum generation capacity of the power generation module 506 and/or a maximum projected load associated with the operation of the grid-independent compute unit 500. For example, the power generation module 506 may comprise 200 square meters of solar panels capable of generating a peak output of 40 kilowatts (kW), in which case an energy capacity of the energy storage module(s) 512 can be determined as a multiple of the 40 kW peak output. Additionally, or alternatively, the capacity of energy storage module(s) 512 can be further based on an average or expected intermittency of the power generated by power generation module 506. In the example in which the power generation module 506 comprises solar panels, the intermittency of power generation corresponds to the intermittency of daylight hours during which the solar panels are able to generate electrical power. In one illustrative example, the energy storage module(s) 512 can store sufficient energy to provide electrical power for at least the duration of the intermittent “down time” of the power generation module 506. For instance, if the grid-independent compute unit 500 is expected to operate in a geographical location associated with a maximum of 10 night-time hours per day, a 40 kW solar panel array could be mated with a 40*10=400 kilowatt-hour (kWh) battery.

In still further examples, the energy storage capacity of the energy storage module(s) 512 may be sized to be greater than the average, or even peak, load from the compute unit 500 components during the intermittent down cycles of the primary power generation 506. For example, as mentioned previously, the grid-independent unit 500 may include propulsion systems such as electric motors for driving wheels, treads, propellors, rotors, etc., to move the grid-independent unit 500 through its surrounding environment and from one geographical location to another. In such examples, the grid-independent unit 500 may utilize battery power (e.g., electrical energy from the energy storage module(s) 512) to power the propulsion systems during transit. The electrical load of operating the propulsion system(s) of the grid-independent unit 500 may far exceed or otherwise be greater than the electrical load of operating the compute components of the grid-independent unit 500 (e.g., the compute/networking unit 530 and/or the communications unit 550). Accordingly, the energy storage module(s) 512 can have an energy capacity sufficient to provide electrical power to the propulsion system(s) of the grid-independent unit 500 for at least a pre-determined amount of time. For instance, in one illustrative example, the energy storage module(s) 512 can be implemented as one or more batteries providing sufficient energy storage capacity and discharge capacity to power the movement of the grid-independent unit 500 while also providing full or partial power to the compute components of the grid-independent unit 500 at the same time. In some aspects, the energy storage module(s) 512 can comprise a plurality of 140 kWh battery packs, although it is appreciated that various other configurations and/or energy storage capacities may also be utilized for the energy storage module(s) 512 without departing from the scope of the present disclosure.

In some aspects, the propulsion system (e.g., one or more electrical drive motors) of a grid-independent edge computing apparatus 500 can be integrated with or within the housing 570. Alternatively, an external propulsion system or propulsion unit can be associated with the grid-independent edge computing apparatus 500, for example transporting the grid-independent apparatus 500 based on coupling the external propulsion system to the housing 570. In some embodiments, a control system and/or power delivery system of the propulsion system can be communicatively coupled with the grid-independent edge computing apparatus 500. In one illustrative example, the propulsion system (whether internal to the grid-independent apparatus 500 or external to the grid-independent apparatus 500) can include electrical motors that draw power from the energy storage module 512 included in the power unit 510 of the grid-independent apparatus 500. The energy storage module 512 (e.g., one or more batteries) can be used to power the propulsion system to advance the grid-independent apparatus 500 through the environment.

Based on determining that the energy storage module 512 has been depleted below a pre-determined threshold (e.g., the batteries being discharged below a certain level, being fully discharged, being discharged until the output voltage drops below a threshold, etc.), the grid-independent edge computing apparatus 500 can be configured to cease movement/travel through the environment. In particular, the grid-independent edge computing apparatus 500 can park in a suitable location having an energy source 502 available to recharge its batteries (e.g., to recharge the energy storage module(s) 512). For instance, when the grid-independent edge computing apparatus 500 includes power generation modules 506 implemented as solar panels, the suitable energy source 502 is sunlight. As such, the grid-independent edge computing apparatus 500 can determine that its current battery state of charge is insufficient to continue traveling, and can identify a suitable location to park and deploy its solar panels (e.g., the power generation modules 506) to capture sunlight (e.g., energy source 502) that can be used to generate electrical power to recharge the batteries (e.g., the energy storage module(s) 512).

In some embodiments, the grid-independent edge computing apparatus 500 can utilize an internal propulsion system to perform autonomous or semi-autonomous travel and movement through its surrounding environment. The autonomous and/or semi-autonomous travel can be implemented using dedicated compute components included in the grid-independent edge computing apparatus 500 for purposes of implementing travel. In other example, the autonomous and/or semi-autonomous travel can be implemented using shared compute components and capacity provided by the compute/networking unit 530. In scenarios in which the grid-independent edge computing apparatus 500 is moved through the environment using an external propulsion unit (e.g., a detachable tractor or other vehicle for towing the housing 570), upon reaching an intended deployment area or location, the grid-independent edge computing apparatus 500 can be detached or otherwise decoupled from the external propulsion unit and activated to provide various edge compute services and/or satellite internet constellation communication services as needed. In some embodiments, the external propulsion unit can remain in the new location in which the grid-independent edge computing apparatus 500 has been deployed. For example, the external propulsion unit can be detached or decoupled from the housing 570 and may be parked or stored in the general vicinity of the housing 570. In some embodiments, the external propulsion unit can be detached from a towing or traveling configuration associated with transporting the grid-independent edge computing apparatus 500, but may remain electrically coupled to the grid-independent edge computing apparatus 500 (e.g., drawing electrical power via a connection to the power unit 510 of the grid-independent edge computing apparatus 500). The disconnection of the external propulsion unit and the grid-independent edge computing apparatus 500 can enable better flow of air through the housing 570, to more efficiently and effectively provide cooling while in operation.

In other cases, an external propulsion unit can be used to transport the grid-independent edge computing apparatus 500 to a desired deployment location, and may leave after the grid-independent edge computing apparatus 500 has been dropped off and/or deployed in the new location. In some aspects, the grid-independent edge computing apparatus 500 can initially be deployed into a particular location using an external propulsion unit such as a tractor or truck, with subsequent movement and re-locations performed using an internal propulsion system (e.g., electrical motors) of the grid-independent edge computing apparatus 500.

In some embodiments, the power unit 510 can include one or more internal switches configured to vary the pathway coupling the input electrical energy received from the power generation module 506 to the output electrical energy provided by the power unit 510. In some examples, the output electrical energy of power unit 510 can be transmitted to an electrical bus 572 that interconnects some (or all) of the electrically powered components included in the grid-independent unit 500. For example, the electrical bus 572 can be powered directly by power unit 510 by closing a switch that connects an output of the transformer (included in power unit 510) to the electrical bus 572. In this example, the transformer of power unit 510 can directly couple AC electricity onto the electrical bus 572. In another example, electrical bus 572 can be powered using the one or more batteries or other energy storage devices 512 included in power unit 510. In this example, the energy storage devices 512 can be charged with DC power generated as output by the rectifier of power unit 510 (e.g., wherein the rectifier receives AC electricity from the transformer based on closing a switch between the transformer and the rectifier). The energy storage devices 512 can output DC electricity, which is converted to AC electricity by the inverter of power unit 510 and then coupled onto the electrical bus 572 as output.

As illustrated, the power unit 510 can provide grid-independent electrical power, via electrical bus 572, to the cooling unit 520, the compute/network unit 530, the safety/monitoring unit 540, and/or the communications unit 550.

Additional interconnections within the grid-independent unit 500 can include a cooling loop and/or a heat exchange loop between the cooling unit 520 and various other internal units. For example, the cooling unit 520 can provide a cooling loop to one or more (or all) of the power unit 510, the communications unit 550, and/or the compute/networking unit 530, and can provide a heat exchange loop to one or more (or all) of the power unit 510, the communications unit 550, and/or the compute/networking unit 530. At the cooling unit 520, both the cooling loop and the heat exchange loop can terminate at a heat exchanger 526. In one illustrative example, the cooling unit 520 can be a compressor-based cooling unit, and may include a compressor (e.g., a centrifugal compressor in the example of FIG. 5), a coolant reservoir, an orifice, and a condenser 524 (among various other components). In some embodiments, the condenser 524 can be provided wholly external to the housing 570. In some examples, the condenser 524 can be provided partially internal to the housing 570 and partially external to the housing 570. In operation, the condenser 524 can release or collect heat, as is appropriate for the operation of the cooling unit 520. For instance, the condenser 524 can be configured to vent or otherwise release heat from the interior of housing 570 into the surrounding environment/exterior of housing 570.

In some embodiments, such as when the cooling unit 520 is implemented as an air-cooled cooling unit, the condenser 524 can include an integrated fan 522 for dissipating waste heat generated within the housing 570 (e.g., represented in FIG. 5 as heat dissipation 523). In some aspects, the fan 522 can draw in ambient air from a cooling source 521 and pass the ambient air over the coils of condenser 524. It is noted that in some embodiments, the cooling source 521 and the heat sink 523 can be the same. In another example, the cooling unit 520 can be implemented as a liquid-cooled cooling unit (e.g., water-cooled), in which case the condenser 524 can be associated with or otherwise coupled to a pump 522. The pump 522 can be external to and/or separate from the condenser 524, and operable to draw in (e.g., provide an intake) of fluid, such as a water from an environmental body of water nearby to the grid-independent unit 500. In some aspects, the grid-independent compute unit 500 can be configured to operate with an external cooling source interface, such that the grid-independent compute unit 500 can be “plugged in” or otherwise coupled to an external water or air chiller. In some cases, the orifice depicted in cooling unit 520 can include a condenser inlet and a condenser outlet that are the same or otherwise have same or similar appearances to one another. In some embodiments, the cooling unit 520 can be associated with a coefficient of performance (COP) in a range of approximately 2-4. In some cases, the cooling unit 520 can be associated with a COP of at least 2. Stainless steel hardlines may be utilized for coolant.

As contemplated herein, the cooling unit 520 can be configured to provide a cooling capacity that is based at least in part on dynamic conditions, such as ambient environmental conditions (e.g., ambient temperature, day or night, direct sun on housing 570 or overcast/shadows on housing 570, etc.) and ambient internal conditions within housing 570. Cooling unit 520 can additionally be configured to provide adequate cooling capacity across different seasonal demand profiles. For example, during summertime operations or the grid-independent edge computing apparatus 500, extra power demands may be made by the cooling unit 520 in order to account for the heating of housing 570 from direct (or indirect) sunlight and/or to account for increased ambient temperatures (day and night). In one illustrative example, when the grid-independent apparatus 500 utilizes solar panel arrays for the power generation module 506, the increased power demands of cooling unit 520 during summertime may correspond (either partially or wholly) to an increase in the power generated by the solar panel arrays of power generation module 506, based on solar panels operating for longer periods of time due to the relatively longer days of summer and/or based on solar panels operating at a higher peak and average power output due to the more direct incidence of sunlight on the solar panels. In some aspects, the fan or pump 522 associated with condenser 524 and utilized to perform heat exchange with the surrounding environment outside of housing 570 can be sized to be sufficiently powerful to exchange the air within the interior of housing 570 faster than the internal components within housing 570 can heat the air beyond a pre-determined temperature threshold. For example, the fan or pump 522 can be sized to deliver a pre-determined cubic feet per minute (CFM) of air exchange, wherein the CFM of air exchange is a multiple of the total volume (e.g., also in cubic feet) of the interior of housing 570.

The compute/networking unit 530 can include computing hardware for providing edge computing and/or data services at the grid-independent unit 500. In one illustrative example, the compute/networking unit 530 (referred to interchangeably as a “compute unit” or a “networking unit” herein) can include a plurality of servers and/or server racks. As depicted in FIG. 5, the compute unit 530 can include a first server rack 534a, a second server rack 534b, . . . , and an n-th server rack 534n. The server racks can each include same or similar hardware. In some embodiments, different server racks of the plurality of server racks can each be associated with different hardware configurations.

In some embodiments, the server racks 534 can be implemented as existing, vertical server racks in which individual servers are vertically stacked atop one another. In other examples, the server racks 534 can be provided in a more horizontally distributed manner, either without maximizing the total available vertical space within housing 570 or with minimal vertical stacking of servers (or even no vertical stacking of servers). For instance, the server racks 534 can comprise “flattened” implementations of standard vertical server racks, with a plurality of servers and/or motherboards spatially distributed across the horizontal surface area of the floor of housing 570. In some embodiments, each server rack 534 (and/or some or all of the constituent servers or motherboards of each server rack) can be associated with or otherwise coupled to one or more heatsinks for more efficiently dissipating waste heat. In some aspects, the server racks 534 can be implemented using horizontally distributed motherboards spread out along the bottom surface of housing 570 and coupled to corresponding heatsinks on the bottom surface of housing 570. For example, each server rack may be associated with 5-10 CPU motherboards on heatsinks mounted to the bottom surface (e.g., floor) of housing 570, although it is noted that various other configurations and CPU′ motherboard quantities may also be utilized without departing from the scope of the present disclosure.

The server racks 534 can include various combinations of CPUs, GPUs, NPUs, ASICS, and/or various other computing hardware associated with a particular deployment scenario of the grid-independent edge computing apparatus 500. In some embodiments, the compute/networking unit 530 can include one or more data storage modules, which can provide onboard and/or local database storage using HDDs, SSDs, or combinations of the two. In some aspects, one or more server racks (of the plurality of server racks 534a-n) can be implemented either wholly or partially as data storage racks. In some examples, each server rack of the plurality of server racks 534a-n can include at least one data storage module, with data storage functionality distributed across the plurality of server racks 534a-n. In some embodiments, the compute/networking unit 530 can be configured to include multiple petabytes of SSD and/or HDD data storage, although greater or lesser storage capacities can also be utilized without departing from the scope of the present disclosure.

The communications unit 550 can be used to perform wired and/or wireless communications over one or more communications media or modalities. For example, as illustrated, the communications unit 550 can be used to implement a data downlink (DL) 551 and a data uplink (UL) 553. In one illustrative example, the communications unit 550 can include one or more satellite transceivers (e.g., also referred to herein as satellite dishes), such as the first satellite dish 552a and the second satellite dish 552b. In some embodiments, both of the satellite dishes 552a, 552b can be configured for bidirectional communications (e.g., capable of receiving via data downlink 551 and capable of transmitting via data uplink 553). In some aspects, one of the satellite dishes 552a, 552b may be configured as a receiver only, with the remaining one of the satellite dishes 552a, 552b configured as a transmitter only. Each of the satellite dishes 552a, 552b can communicate with one or more satellite constellations, including satellite internet constellations such as those described previously above.

In some embodiments, the communications unit 550 can include an internal switching, tasking, and routing module 556 that is communicatively coupled to the satellite dishes 552a, 552b and used to provide a network link 558 to the compute unit 530. Although not illustrated, it is appreciated that the communications unit 550 and/or the internal switching, tasking, and routing module 556 can be configured to provide network links to one or more (or all) of the remaining components of the grid-independent edge compute apparatus 500, for example to provide control commands from a remote user or operator.

In some cases, the communications unit 550 can include one or more antennas and/or transceivers for implementing communication types other than the satellite data network communications implemented via the first and second satellite dishes 552a, 552b. For instance, the communications unit 550 can include one or more antennas or transceivers for providing beamforming radio frequency (RF) signal connections. In some embodiments, beamforming RF connections can be utilized to provide wireless communications between a plurality of grid-independent compute units 500 that are within the same general area or otherwise within radio communications range. In some examples, a plurality of beamforming RF connections formed between respective pairs of grid-independent compute units 500 can be used as an ad-hoc network to relay communications to a ground-based internet gateway. For example, beamforming RF radio connections can be used to relay communications from various grid-independent compute units 500 to one or more ground-based internet gateways that would otherwise be reachable via the satellite internet constellation (e.g., beamforming RF radio relay connections can be used as a backup or failover mechanism for the grid-independent compute unit 500 to reach an internet gateway when satellite communications are unavailable or otherwise not functioning correctly).

Local radio connections between can be seen to enable low latency connectivity between a plurality of grid-independent edge computing units 500 that are deployed in a given geographical area or region. In some embodiments, a plurality of grid-independent edge computing units 500 that are deployed in a same area/region and/or that are interconnected via an ad-hoc RF relay network may be referred to as a “fleet” of grid-independent edge computing units.

In one illustrative example, various functionalities described above and herein with respect to the grid-independent edge computing unit 500 can be distributed over the particular units included in a given fleet. For instance, each grid-independent unit 500 may include an RF relay radio or various other transceivers for implementing backhaul or point-to-point links between the individual units included in the fleet. However, in some examples only a subset of the grid-independent units 500 included in a fleet may need to be equipped with satellite dishes for communicating with a satellite internet constellation (e.g., the first and/or second satellite dishes 552a, 552b). For instance, a grid-independent computing unit that does not include the satellite dishes 552a, 552b may nevertheless communicate with the satellite internet constellation by remaining within RF relay range of one or more grid-independent edge computing units 500 that do include the satellite dishes 552a, 552b.

In some embodiments, the distribution of functionalities across various grid-independent units 500 included in a fleet can include configuring a first subset of the grid-independent units 500 to operate or deploy as mobile data centers while configuring a second subset of the grid-independent units 500 to operate to perform one or more replenishment tasks in service of the mobile data centers. For instance, a mobile data center unit may be deployed at a location that is serviced only by the satellite constellation internet connectivity. If the mobile data center generates and/or ingests large amounts of data, or if the available bandwidth from overhead birds of the satellite internet constellation is limited, the rate at which data accumulates to the mobile data center may exceed the available satellite internet constellation bandwidth. Rather than attempting to compress the data for more efficient upload using the limited satellite internet constellation bandwidth, transmitting only a portion of the data, and/or transmitting the full data while accumulating an ever-growing backlog, the systems and techniques can be configured to perform replenishment operations in which compute components of a mobile data center containerized unit are swapped out. In this manner, data transfer can be performed by physically transporting hard drives or SSDs filled with data at the mobile data center to a centralized location for ingestion via direct/wired connection and/or by physically transporting the data-filled drives to a location in which higher bandwidth internet access is available (e.g., a fiber or other wired connection point to the internet). The data-filled drives can be exchanged, in the field, by installing a new replacement drive into the mobile data center unit to replace each data-filled drive that is removed for data ingestion.

In some aspects, the replenishment operations can be performed by a grid-independent unit 500 operating in an autonomous, partially autonomous, or remote controlled navigation mode. In some examples, replenishment operations can be performed manually or by third-parties given secure access to the internal components of the grid-independent mobile data center unit 500. Replenishment operations can additionally, or alternatively, be performed to swap out compute components/hardware, for instance to perform an upgrade, replace failing or failed parts, etc. In one illustrative example, replenishment operations can be performed to help sustain ongoing grid-independent power generation operations at a deployed mobile data center apparatus. For instance, the mobile data center apparatus may include a backup diesel generator and supply of diesel fuel (e.g., on onboard diesel tank), as described previously above. The backup diesel generator can be used to achieve improved operational up-time and reliability of the mobile data center apparatus, based on using the diesel generator and stored diesel fuel to generate electricity when the primary generation means (e.g., solar panels, wind turbines, etc.) have failed, become unreliable or only partially operational, when weather conditions or environmental conditions prevent sufficient energy generation using the primary generation means, etc.

In some aspects, a replenishment operation can be performed to deliver additional stocks or supplies of diesel fuel to deployed mobile data center units having diesel fuel storage levels below a threshold, that have been exhausted, are projected to be depleted within a pre-determined threshold time frame, are projected to be deployed prior to a next scheduled replenishment operation, etc.

In some examples, a fleet of containerized mobile data center units can be deployed in an approximately same geographic area or region. For instance, a plurality of containerized mobile data center units can deploy in sufficiently close proximity so as to support wired interconnections between at least some of the individual units. In such examples, a subset of the containerized mobile data center units may be configured to provide backup or emergency electrical power (via onboard diesel generation using stored diesel fuel) to multiple other mobile data center units that are in the same fleet/physically connected via wired cable for electrical transmission. In such scenarios, replenishment operations can be reduced in frequency, as only the subset of the fleet includes diesel generators needing diesel fuel replenishment on a periodic basis.

The grid-independent edge computing apparatus 500 can additionally include a safety/monitoring unit 540, which can be used to oversee deployment and operation of the apparatus in various environments, locations, conditions, etc. In one illustrative example, the safety/monitoring unit 540 includes a fire suppression module 542, a drone or UAV 544, and a plurality of cameras and sensors 546, 548. Fire suppression module 542 can be used to provide automated fire suppression and/or firefighting capabilities to the grid-independent apparatus 500. For instance, fire suppression module 542 can be a Halon-type automated fire suppression system that is installed within the interior volume of housing 570. In some aspects, a first fire suppression module 542 can be provided in association with the housing 570 or compute unit 530, while a second fire suppression module 542 can be provided in associated with the power unit 510 and/or the power generation module 506.

The drone or UAV 544 can be an external drone that docks to the housing 570 (or other docking receptacle associated with the safety/monitoring unit 540). In some embodiments, the drone 544 can be docked and stored within the interior of housing 570, and may be deployed to navigate about the external environment surrounding housing 570 (e.g., the environment in which the grid-independent edge computing apparatus 500 is located). The drone 544 may also be docked and stored outside of housing 570, deployable to more immediately begin examination and data ingestion corresponding to the external surrounding environment.

In one illustrative example, the drone 544 can be used to perform physical perimeter inspection within the vicinity of the grid-independent edge computing apparatus 500.

The drone 544 can be manually operated by a remote pilot, can operate semi-autonomously, and/or may operate fully autonomously. Manual operation by a remote pilot can be performed via remote control commands received via the data downlink 554 and transmitted to a corresponding receiver or control system onboard the drone 544 (the remote control commands can be transmitted by a remote pilot based on the data uplink 553 being used to transmit video and/or sensor data information collected by the drone 544 to the remote pilot). In some embodiments, the drone 544 can autonomously perform docking and/or de-docking maneuvers (e.g., wherein de-docking corresponds to the drone 544 deploying or launching from a stored configuration and docking corresponds to the drone 544 returning from an active inspection configuration to the stored configuration).

The safety/monitoring unit 540 can include various cameras and sensor systems 546, 548 for performing monitoring functions associated with the deployment and/or operation of the grid-independent edge computing apparatus 500. For example, one or more cameras can be configured to obtain image and/or video data of the surrounding environment (e.g., one or more cameras can be mounted outside of the housing 570) and one or more cameras can be configured to obtain image and/or video data of the internal environment (e.g., one or more cameras can be mounted inside of the housing 570). Similarly, one or more sensors, sensor arrays, sensor systems, etc., can be provided internal to the housing 570 and/or external to the housing 570. For example, sensors can be used to monitor ambient internal environment conditions and sensors can be used to monitor ambient external environmental conditions. In some embodiments, the parameters and ambient conditions monitored for the interior environment and the external environment can be the same or similar (e.g., temperature, humidity, light intensity, vibrations, sound, movement, etc.). The sensor data can be collected as instantaneous measurements and/or can be compiled into time-series or historical sensor data sets indicative of trends in interior and/or exterior monitored parameters and ambient conditions.

In some embodiments, the safety/monitoring unit 540 can be further configured to utilize the camera information, sensor information, drone information, and/or various other monitoring information in order to perform full systems load balancing and optimization (e.g., internal) across the constituent units and components of the grid-independent edge computing apparatus 500. For example, based on detecting an increased computational load or utilization of the compute/networking unit 530, the safety/monitoring unit 540 may be configured to increase the electrical power supplied by power unit 510 and/or the electrical power generated by the power generation module 506. In response to the same trigger condition, the safety/monitoring unit 540 may also be configured to increase the cooling delivered by cooling unit 520. In some embodiments, the safety/monitoring unit 540 can be used to implement full systems load balancing and optimization in both predictive and reactive manners. For example, predictive load balancing and optimization can be performed based on an analysis of historical data, trends, and observations determined by the safety/monitoring unit 540 with respect to prior operation and operational conditions of the grid-independent edge computing apparatus 500. In the context of the example above, predictive load balancing and optimization can be performed to increase electrical power supplied by power unit 510 and/or increase power generated by power generation module 506 prior to an increase in electrical load from the compute/networking unit 530 (e.g., based on a predicted increase in electrical load). Reactive load balancing and optimization can be performed to increase electrical power supplied by power unit 510 and/or increase power generated by power generation module 506 subsequent to observing a change in electrical load or other operating conditions of the grid-independent edge computing apparatus 500 that would necessitate such an increase.

### Grid-Independent Edge Computing Example Apparatus Deployments

The systems and techniques described herein can be used to provide containerized and/or modular grid-independent edge computing apparatuses that can be used to flexibly deploy compute power, data storage, and communications capabilities (including multi-modal communications capabilities) to a variety of different geographical locations. In particular, the grid-independent edge computing apparatuses described herein can be used to deploy edge computing capacity to locations in which traditional electrical and connectivity infrastructure is unavailable or insufficient, thereby providing computing capacity to previously unserved and underserved locations. Moreover, the modularity of the containerized units can be used to support various user-specific and/or deployment-specific configurations of the internal compute, data storage, and/or communications hardware.

In one illustrative example, the containerized units can be designed to support rapid scale up deployments, such that additional edge computing capacity can be brought online by transporting and deploying one or more additional units to a given location. For instance, providing a second containerized unit in a same or similar geographical area as an already deployed unit can, in some embodiments, be associated with an approximate doubling (or more) of the edge computing capacity provided to the area, based on the hardware configuration of the compute components included in the second containerized unit as compared to those included in the first containerized unit.

The containerized edge compute units can be transported via various vehicles and transportation means for deployment in desired locations. Additionally, or alternatively, the containerized edge compute units can be self-propelled, for example via one or more onboard electric motors. In some embodiments, the ability of the containerized edge compute units to be easily positioned and repositioned, including in autonomous fashion, can be seen to better support data residency requirements associated with computational operations and/or cloud services implemented using the compute hardware of a containerized edge compute unit.

In one illustrative example, the containerized edge compute units can be the same as or similar to the grid-independent edge computing apparatus 500 described above with respect to FIG. 5. The containerized edge compute units can be wholly (or partially) energy independent and can be wholly (or partially) mobile. In some aspects, the containerized edge compute units can be mounted to a vehicle or otherwise transported by a vehicle. In some embodiments, the containerized edge compute unit can be integrated with a vehicle.

Based on providing the containerized edge compute units with satellite internet constellation connectivity, the containerized edge compute units may deployed in any location in which a satellite internet constellation is reachable (either directly or via one or more intermediate relay link), that is physically reachable for deployment/parking of the containerized edge compute unit, and that includes a suitable energy source from which the containerized edge compute unit can self-sufficiently generate its necessary electrical power without connection to the grid or other electrical infrastructure.

As contemplated herein, the containerized edge compute units may be configured for land-based deployments, water-based deployments, or both. The containerized edge compute units can be deployed individually, deployed in pairs, or deployed in a plurality of associated units that may be collectively referred to as a “fleet.” Each respective containerized edge compute unit can be associated with a single user or entity and/or may be associated with multiple users, entities, or tenants. For instance, one or more respective containerized edge units deployed to provide edge computing and satellite internet constellation connectivity at a remote location such as a mine may each be associated with a single entity (e.g., a mining company or operator of the mine). In another example, one or more respective containerized edge units may be deployed to provide satellite CDN services, in which case each respective containerized unit can be associated with a plurality of different users (e.g., users of the satellite internet constellation that are served CDN content, etc.).

In some aspects, the containerized grid-independent edge computing apparatus described herein can be used to provide secure, low-latency edge computing. Illustrative example use cases can include, but are not limited to, deploying one or more containerized grid-independent computing apparatuses to support a military operation in a remote location that otherwise lacks traditional electrical and internet network connectivity infrastructure; deploying one or more units at various oil well locations and mining operation locations scattered across the globe (e.g., owned by or associated with an energy company); deploying one or more units to provide edge computing services for an investment bank associated with strict security, data residency, and/or ESG requirements; deploying one or more units to provide edge computing services to government agencies and/or operations that generate and/or receive top secret data; deploying one or more units to provide edge computing services to a critical infrastructure provider being targeted by nation state actors; etc.

In some aspects, the containerized grid-independent edge computing apparatus described herein can be used to augment and expand gaps in traditional infrastructure, on both a regional level, a national level, and/or an international level. For instance, as countries of the world continue down the path of de-globalization, many geographies have largely been overlooked or otherwise underserved by existing providers of internet connectivity and/or compute infrastructure. For example, existing data residency infrastructure is highly consolidated into only a few dozen different locations around the world, even when considering the existing market of data residency infrastructure providers as a whole.

Notably, the containerized grid-independent edge computing apparatus described herein can be deployed to provide localized edge computing and data residency services that are combined with low-latency satellite internet bandwidth (via connectivity to a satellite internet constellation). The containerized grid-independent edge computing apparatus described herein can additionally be deployed in one or more fleets that can be used to provide distributed computing, data residency, and other cloud services based on combining the local resources available at each localized deployment of a mobile and grid-independent data center.

FIG. 6 is a diagram illustrating an example of a grid-independent edge computing apparatus 600 implemented using a towable housing that includes one or more deployable energy generation modules, in accordance with some examples. In some aspects, the apparatus 600 can be implemented using an architecture that is the same as or similar to the example architecture 500 described above with respect to FIG. 5.

In some embodiments, the grid-independent edge computing apparatus 600 can be associated with a containerized unit 690 and a propulsion unit 610. In the context of FIG. 6, the propulsion unit 610 is depicted as being external to and separate from the containerized unit 690, although it is noted in some embodiments the propulsion unit 610 may be integral to or otherwise combined with the containerized unit 690 (e.g., as described previously above). In one illustrative example, the propulsion unit 610 can be provided as a tractor unit (also referred to as a semitruck or a semi-trailer truck), as depicted in FIG. 6. Similarly, the containerized unit 690 can be implemented based on a standard shipping container form factor.

For instance, the containerized unit 690 can comprise a housing 670 that is the same as or similar to a shipping container. In some embodiments, the housing 670 can be a 40-foot vented shipping container. As will be described in greater depth below, the housing 670 may be made from steel (e.g., the same as or similar to existing shipping containers) and may be stackable. In other examples, the housing 670 may be made from a non-steel material, based on the ability to deploy the containerized units 690 across wide geographical areas that may reduce or eliminate the need to stack the units (and hence, the need for the housing 670 to be made of a material having sufficient strength to be stackable). For instance, lighter and more cost effective materials than steel can be used to form the housing 670. In some embodiments, the containerized unit 690 can comprise a housing 670 that has a form factor the same as or similar to a shipping container, but in a size (e.g., length) greater than 40-feet. In some aspects, the design, shape, and/or dimensions of the housing 670 can be determined based at least in part on applicable rules and regulations governing the types of trailers (and therefore containers carried by the trailers) that can be attached to semitrucks (or other propulsion units 610) in the particular location(s) in which the containerized unit 690 is to be deployed.

In some embodiments, the containerized unit 690 comprises a housing 670 that is permanently attached to a trailer bed which itself can be removably attached and detached from a coupling on the propulsion unit 610. In other examples, the housing 670 can be removably attached to the trailer bed, such that the housing 670 is mounted to the trailer bed for transportation using propulsion unit 610 and is subsequently removed from the trailer bed for deployment and/or propulsion under its own power.

As illustrated in FIG. 6, the housing 670 can define an interior volume in which various components and modules can be provided. In some embodiments, the housing 670 can include one or more (or all) of the power unit 510, cooling unit 520, compute/networking unit 530, safety/monitoring unit 540, and communications unit 550 described above with respect to FIG. 5. For instance, FIG. 6 depicts a plurality of components 660, which can include satellite internet constellation communications terminals (e.g., which can transmit and receive to birds of a satellite internet constellation using the satellite dish 662). The plurality of components 660 can additionally, or alternatively, include one or more servers, server racks, or other compute components associated with implementing the compute/networking unit 530.

The housing 670 is further shown as including two air inlet/outlet openings 620a and 620b, although a greater or lesser quantity may also be utilized. In this example, a first ventilation opening 620a is shown on a first distal end of the housing 670 and a second ventilation opening 620b is shown on a second distal end of the housing 670, opposite from the first ventilation opening. Additional configurations, locations, placements, etc., may also be utilized without departing from the scope of the present disclosure. In some embodiments, the ventilation openings 620a, 620b can be included in a cooling unit that is the same as or similar to the cooling unit 520 of FIG. 5.

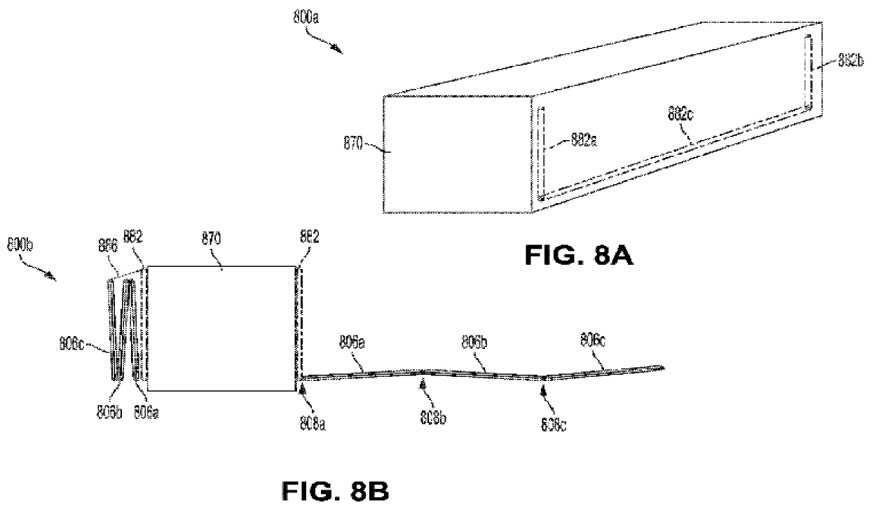

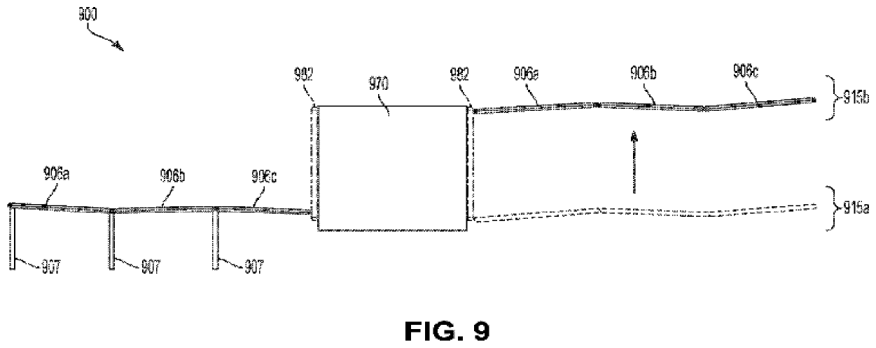

A plurality of solar panel arrays 606 can be included in, coupled to, or otherwise associated with the containerized unit 690. In the example of FIG. 6, the solar panel arrays 606 are depicted as being attached to the top surface of the housing 670, although various other configurations are also contemplated (e.g., such as those described below with respect to FIGS. 8 and 9). In some embodiments, the solar panel arrays 606 can be the same as or similar to the power generation module(s) 506 of FIG. 5. For instance, the solar panel arrays 606 can be deployed to generate electrical power using sunlight incident upon the exposed surface of the solar panel arrays 606. The generated electrical power can be used to power the containerized edge computing unit 690 and its constituent components. In some embodiments, the generated electrical power may be stored (e.g., in a batter or other energy storage module, not shown in FIG. 6) and utilized to power, either partially or wholly, propulsion systems associated with the containerized unit 690 (e.g., including the external propulsion unit 610 and/or internal propulsion systems of the containerized unit 690, not shown). In some aspects, the solar panel arrays 606 can be foldable, collapsible, or otherwise movable between a deployed position and a stowed position. For example, the stowed position can be a more compact position associated with a smaller footprint or total surface area as compared to the deployed position. In one illustrative example, in the stowed position the solar panel arrays 606 can fold back upon one another to occupy a footprint approximately equal to the surface area of the top of the housing 670. In another example, in the stowed position the solar panel arrays 606 can occupy a footprint equal to the surface area of the top of the housing 670 plus at least a portion of the surface area of the vertical sides of the housing 670 (e.g., based on the solar panel arrays 606 folding in the stowed position to be approximately flush with the outer surfaces of the housing 670).

The quantity, size, type, efficiency, etc. of the solar panel arrays 606 can be selected based on a maximum dimension and/or weight the installation of which can be supported by the housing 670 and/or the propulsion unit 610. The quantity, size, type, efficiency, etc. of the solar panel arrays 606 can additionally be selected based on a threshold or minimum quantity of electrical power needed for the operation, deployment, and/or movement of the containerized unit 690. In some cases, the quantity of compute units (e.g., servers, server racks, CPUs, GPUs, etc.) installed in the containerized unit 690 can be determined based at least in part on the available electrical generation capacity associated with the solar panel arrays 606. For example, the quantity of compute units (and/or a battery storage capacity) can be selected such that consistent service and operation of the containerized unit 690 can be achieved year-round and across a range of anticipated environmental conditions. In some cases, additional solar panel arrays may be provided on solar panel platform that unfold from the front and/or back vertical faces of the housing 670 to thereby increase the solar panel area (and therefore, the solar panel electricity generation capacity). In some examples, solar panel platforms can unfold from the sides of the housing 670 and then expand in a sliding or telescoping action from the unfolded position to thereby increase the solar panel area even further.

As mentioned previously, one or more grid-independent edge computing apparatuses can also be implemented as water-based containerized units configured for deployment and operation on the surface of a body of water, partially submerged in a body of water, and/or fully submerged in a body of water. FIG. 7 is a diagram illustrating an example of a grid-independent edge computing apparatus 700 implemented using a water-going vessel housing 770, in accordance with some examples. The apparatus 700 can be implemented using an architecture the same as or similar to the example architecture 500 of FIG. 5. For example, the water-going vessel housing 770 may be the same as or similar to the housing 570 of FIG. 5, etc.

As illustrated, the water-going vessel housing 770 can be provided as a surface vessel such as a boat, barge, ship, etc. In some embodiments, the surface vessel can be uncrewed, and may be operated manually, semi-autonomously, or fully autonomously. Manual operation can be performed remotely. In some aspects, the water-going vessel housing 770 can include a plurality of solar panels 706, which may be used to implement a power generation module that is the same as or similar to the power generation module 506 of FIG. 5. As illustrated, the solar panels 706 can occupy a surface area or total footprint that is less than or equal to a footprint or upper surface area of the water-going vessel housing 770. In some embodiments, the solar panels 706 can unfold, telescope, or otherwise expand to occupy a surface area that is larger than the footprint of the water-going vessel housing 770. Additionally, or alternatively, the grid-independent apparatus 700 can implement energy generation technologies other than solar panels. For instance, the grid-independent apparatus 700 can implement a hydro-powered mobile data center with satellite constellation internet connectivity. In some embodiments, the grid-independent apparatus 700 can capture and generate electrical energy using tidal or wave generator means, thermal means, etc.

In some embodiments, the water-going vessel housing 770 can be provided as a hovercraft-type vehicle that operates by using one or more blower fans to hover over the horizontal surface (either water or land) and one or more blower fans to propel the vehicle forward in the horizontal direction. Similarly, a land-based vessel housing (such as the housing 670 of FIG. 6) can also be implemented as a hovercraft-type vehicle using onboard hovercraft-type propulsion systems. In some cases, a hovercraft-based implementation for propulsion of the containerized mobile data center disclosed herein can be seen to traverse more complicated terrain by virtue of hovering above the terrain. In some embodiments, the hovercraft-based implementation can use various types of ground effect propulsion systems, and can be designed to float and/or be towed across waterways, seas, oceans, and land terrain.

### Grid-Independent Edge Computing Deployable and Configurable Power Generation

FIG. 8A is a diagram 800a illustrating an example of a grid-independent edge computing apparatus, in accordance with some examples. In particular, FIG. 8A illustrates a perspective view of an example housing 870, which is depicted as being implemented using a shipping container or otherwise generally rectangular form factor.

In one illustrative example, a power generation module can comprise one or more solar panel platforms, each solar panel platform having one or more solar panels mounted thereto. In some embodiments, the power generation modules used to provide grid-independent power to the apparatus 800 can be coupled to the housing 870 using one or more coupling mechanisms mounted to the housing 870.

For instance, FIG. 8A depicts an example in which one or more rails 882 are attached to the outer surface of housing 870 and adapted to provide a mounting or coupling point between housing 870 and various power generation modules (e.g., solar panel platforms, etc.). In particular, the rails 882 can comprise a U-shaped coupling mechanism provided on one (or both) of the vertical sides of the housing 870 along its length. The rails can, in some embodiments, comprise metal bars or other rails that are permanently affixed (e.g., welded, etc.) to the outer surface of the housing 870. A pair of vertical rails 882a, 882b may have same or similar dimensions to one another and may each span approximately the height of the housing 870. In some cases, the vertical rails 882a, 882b can each have a length that is less than the height of the housing 870. The pair of vertical rails 882a, 882b can be respectively coupled to the distal ends of a horizontal rail 882c that spans a substantial portion of the horizontal length of the housing 870. The horizontal rail 882c can be installed at or near a base of the housing 870, on one (or both) of the length-wise vertical faces of the housing 870. In some embodiments, one or more length-wise and/or diagonal cross-bars (not shown) can be included and attached to the vertical rails 882a, 882b in order to hold the vertical rails 882a, 882b in a vertical position and/or to otherwise provide additional stability.

FIG. 8B is a diagram 800b illustrating example configurations of deployable solar panels provided on a housing of a grid-independent edge computing apparatus, in accordance with some examples. In particular, FIG. 8B depicts a front view of the housing 870 depicted in FIG. 8A. Also shown in the front view of FIG. 8B are U-shaped rails 882 provided on either side of the housing 870 (e.g., as depicted in FIG. 8A), although it is noted that in some cases, the U-shaped rails 882 may be provided on only a single side of the housing 870.

In one illustrative example, the U-shaped rails 882 can be coupled, on both sides, to a respective solar panel platform array that is configured to unfold and expand to increase the solar surface area available to generate electricity for powering the grid-independent edge computing apparatus implemented within the housing 870. For instance, a plurality of platforms or trays can be provided, each having one or more solar panels. The plurality of solar panel platforms can be coupled to one another using hinges (or other foldable coupling mechanisms) at the edges of adjacent platforms. For example, a first solar panel platform 806a can be rotatably coupled to the rail 882 at a hinge point 808a (e.g., the hinge point between the edge of solar panel platform 806a and the bottom of the rail 882). In some aspects, the hinging mechanism can have a length that is approximately the same as the length of the solar panel platform. For instance, the solar panel platforms 806a-c can each have a length that is approximately equal to the length of the horizontal rail component 882c (which is itself approximately the same as the horizontal length of the housing 870). In this example, the hinging mechanism can be provided as a continuous, or discontinuous, hinge over the length of the hinge interfaces between the solar panel platform 806a and the rail 882, as well as the hinge interfaces between the solar panel platform pair 806a, 806b and the solar panel platform pair 806b, 806c (associated with the hinge points 808b, 808c, respectively). The solar panel platform pair 806a, 806b can be rotatable coupled to one another via one or more hinges or hinge mechanisms provided at and/or along the hinge point 808b between the respective edges of solar panel platforms 806a and 806b. Similarly, the solar panel platform pair 806b, 806c can be rotatably coupled to one another via one or more hinges or hinge mechanisms provided at and/or along the hinge point 808c between the respective edges of solar panel platforms 806b and 806c.

As noted previously, the unfolding/expanding solar panel platform arrays can be used to maximize the amount of solar panel surface area exposed to incident sunlight. The solar panel platform array can be deployed from a stowed or folded position (shown on the left-hand side of FIG. 8B) to an unfolded position (shown on the right-hand side of FIG. 8B) using rigging or cables attached to motors that extend the rigging out to allow gravity to unfold the panels into the deployed position. For instance, a rigging cable 886 can be attached to the solar panel platform array at one end and may be spooled around a reel or otherwise coupled to an electrical motor on the housing 870 that is operable to increase or decrease the length of the rigging cable 886. In some aspects, the rigging cable 886 can be run through a center channel or interior volume of the U-shaped rail 882. In one illustrative example, the length of the rigging cable 886 can be increased (e.g., played out or unspooled from the reel upon which the cable is wound, wherein the reel is rotated by the electrical motor mentioned above) in order to deploy the solar panel platform arrays from the folded position on the left to the unfolded position on the right. The length of the rigging cable 886 can be decreased in order to stow the solar panel platform arrays from the unfolded position on the right to the folded position on the left, based on reversing the unfolding process described above (e.g., by rotating the reel upon which the cable is wound in the opposite direction, the solar panel platform arrays can be stowed to their folded position).

As depicted in FIG. 8B, the solar panel platform array on each side of the housing 870 is shown as including three constituent solar panel platforms (e.g., 806a-c), although it is noted that a greater or lesser quantity may be used without departing from the scope of the present disclosure. In the folded or stowed position, the solar panel platforms can be stacked on their respective edges (e.g., oriented with their bottom edge facing downward and their top edge facing upward, as seen in the folded position on the left-hand side of FIG. 8B).

In some embodiments, the vertical rails 882a, 882b of the U-shaped rail coupler 882 can include bars or cables for rigging that provides the appropriate slack for the gravity-assisted unfolding of the solar panel platform arrays 806a-c. In some cases, the cable rigging can be configured to provide a buffer length of cable that remains extended while the solar panel platform arrays 806a-c are in the fully stowed/folded position. For instance, the buffer length of cable can be used to prevent the solar panel platforms 806a-c from folding completely, such that the force of gravity will always act to pull the solar panel platforms 806a-c downward and into the deployed/unfolded position whenever sufficient slack becomes available in the rigging cable. As mentioned above, the rigging cables can be attached to various locations on the top edges of the solar panel platforms 806a-c to ensure that the solar panel platforms fold properly into the stowed position.

In some embodiments, one or more support poles can be coupled to one or more (or all) of the solar panel platforms included in each array of solar panel platforms. For instance, FIG. 9 depicts an example front view of a housing 970 (which may be the same as or similar to the housing 870 of FIGS. 8A and 8B) that includes U-shaped rail couplers 982 (which may be the same as or similar to the U-shaped rail couplers 882 of FIGS. 8A and 8B) on either side of the housing 970. A foldable array of solar panel platforms 906a-c is provided on either side of the housing 970, coupled to the respective ones of the U-shaped rail couplers 982. The foldable array of solar panel platforms 906a-c can be the same as or similar to the foldable array of solar panel platforms 806a-c of FIG. 8B.

On the left-hand side of FIG. 9, the foldable array of solar panel platforms 906a-c is shown as including a plurality of support poles 907 that can hang from each respective one of the solar panel platforms 906a-c. In some embodiments, the support poles 907 can be rotatably coupled to solar panel platforms 906a-c, such that the support poles 907 remain in a substantially vertical orientation throughout the folding and unfolding cycle of the array of solar panel platforms 906a-c. For instance, each support pole 907 can be coupled to a respective one of the hinge joints provided between the edges of adjacent pairs of the solar panel platforms 906a-c.

The support poles 907 may be weighted such that each support pole 907 remains vertical (or slightly outward pointing) when the solar panel platforms 906a-c are oriented in a substantially horizontal position (e.g., fully deployed/unfolded). The weighting of the support poles 907 can additionally be seen to provide additional stability when the solar panel platforms 906a-c are sufficiently unfolded for the support poles 907 to reach or otherwise make contact with the ground upon which the housing 970 is parked or located. In some embodiments, one or more (or all) of the support poles 907 can be telescoping poles capable of increasing and/or decreasing in length as needed to make firm contact with the ground below the solar panel platforms 906a-c when in the unfolded position.

The above discussion has made reference to examples in which a first array of solar panel platforms is provided on the left-hand side of the housing 870/970 and a second array of solar panel platforms is provided on the right-hand side of the housing 870/970. In some embodiments, one or more additional arrays of solar panel platforms can be provided, for instance on the front vertical face of the housing 870/970 and/or on the rear vertical face of the housing 870/970.

In still further embodiments, it is additionally contemplated that each platform itself (e.g., each platform of the plurality of solar panel platforms 806a-c/906a-c) can be a set of vertically stacked or nested platforms that can expand in two distinct stages. In the first expansion stage, an array of solar panel platforms each comprising a nested set of multiple platforms can be unfolded, for example as described above. After unfolding from the vertical stowed position to a horizontal deployed position, one or more (or all) of the nested solar panel platforms can undergo a second stage expansion. In the second stage expansion, each respective primary platform of the array can be expanded in the horizontal direction by sliding out or extending the nested solar panel platforms associated with the respective primary platform. In one illustrative example, the nested solar panel platforms can extend from a primary platform in both directions perpendicular to the direction in which the array of primary platforms was unfolded. In the context of the examples of FIGS. 8A, 8B, and 9, the arrays of primary solar panel platforms are unfolded in the left-right/right-left direction. Accordingly, the nested solar panel platforms can extend from the primary platforms in the direction into the page and in the direction out of the page (relative to the views presented in FIGS. 8B and 9).

In some embodiments, the array of foldable solar panel platforms can be vertically raised and lowered to minimize shadows case on the solar panels by the container housing 970. For instance, when the array of solar panel platforms are unfolded from the base of the container housing (e.g., as shown on the right-hand side of FIG. 8B, and as shown in dotted lines on the right-hand side of FIG. 9), then the container housing 870/970 itself may likely cast a shadow on a non-negligible percentage of the surface of the unfolded solar panel array, for at least some (or all) of the daylight hours during which the solar panel array is operable to generate electricity for the grid-independent edge computing apparatus disclosed herein.

Accordingly, the systems and techniques can utilize one or more poles or tracks provided on the corners of the solar panel platform that couples the overall solar panel array to the housing, such that the overall solar panel array can be vertically raised or lowered relative to the container housing 870/970. As shown on the right-hand side of FIG. 9, in some embodiments an array of solar panel platforms 906a-c can be raised and lowered between a first position 915a (e.g., depicted in FIG. 9 with dotted lines) and a second position 915b. For example, the poles or jacks can be provided at the corners of the first solar panel platform 906a that is immediately adjacent to the housing 970 and coupled to the U-shaped rail 982. In some embodiments, the vertical raising and lowering of the solar panel platforms 906a-c can be implemented using telescoping support poles 907 and a slidable coupling between the first solar panel platform 906a and the U-shaped rail 982.

In some aspects, a geographical area or location in which a containerized mobile edge computing unit is deployed may experience winds that are sufficiently strong (e.g., sufficiently fast) to blow away, damage, or otherwise impede the operation of parts of the system. In such scenarios, the containerized mobile edge computing unit can include a wind detection system that can detect and/or predict when the containerized unit is likely to experience wind conditions that will likely be too strong for continued deployment or safe operation. In some cases, the wind detection system can be implemented by the safety/monitoring unit 540 depicted in the example architecture 500 of FIG. 5. In some cases, the wind detection and prediction can be performed based on a combination of detectors (e.g., sensor data, derived or analyzed sensor data, etc.) and weather forecasts (e.g., obtained via the one or more links to the satellite constellation internet). Based on the wind detection and prediction system indicating that future winds will likely be too strong for continued or safe operation of the solar panel array in the unfolded position, the containerized mobile data center can automatically trigger the solar panel array to be folded into the stowed position prior to the onset of the predicted wind or weather event. After the system detects or determines that the high wind or other weather event has passed, the solar panel array can be automatically triggered to unfold and redeploy. In some embodiments, as a safety precaution, the system may automatically fold and stow the solar panel array at night (e.g., when the solar panels are unable to generate appreciable or significant amounts of electricity above a threshold). The system may additionally, or alternatively, automatically trigger the solar panel array to be folded and stowed on days when the sun is not shining sufficiently to generate appreciable or significant amounts of electricity above a threshold (e.g., on rainy, cloudy, overcast, etc., weather days).

In another example, one or more weighted drapes or curtain mechanism can be attached to the bottom surfaces (e.g., underside) of one or more (or all) of the individual solar panel platforms 906a-c included in a given array of the foldable solar panel platforms. When unfolded, the drapes can be triggered to move by motors that allow the weighted drapes to descend to the ground, thereby blocking off and enclosing the otherwise empty volume between the bottom surface of each solar panel platform and the ground upon which the containerized mobile data center is located. The deployment of the weighted drapes can minimize the amount of wind that can accumulate underneath the platforms themselves.

In some embodiments, the containerized mobile data center may itself include one or more motorized poles that extend out diagonally from the sides of the housing 970 and push into the surface of the ground to stabilize and more effectively brace the housing 970 against wind gusts (e.g., in directions perpendicular to the sides of the housing 970). In some aspects, the stabilization poles extending from the housing 970 may additionally be provided with a windbreaking canvas or windbreaking cover (e.g., as described above with respect to the solar panel platforms 906a-c) to further increase their efficacy.

In one illustrative example, one or more fans may be provided on the sides of the housing 970. For instance, the fans can be included in a cooling unit that is the same as or similar to the cooling unit 520 of FIG. 5. The fans can be powered to vent waste heat generated by the various compute components and other modules within the housing 970. In some cases, the fans are powered to vent waste heat by blowing out hot air from the interior of the housing 970 into the surrounding environment, during low wind situations. For instance, the fans can be the same as or similar to the fans 620a, 620b depicted in FIG. 6. In moderate wind situations, the fan blades may be rotated by the blowing wind, in which case the electrical power supply to the fan motor can be disconnected, such that the fan blades can free wheel and turn the fan motor as they are spun by the environmental wind. By connecting the fan motor to a battery of the containerized mobile data center (e.g., such as the energy storage module(s) 512 of FIG. 5), the fan motor can be driven as an electrical generator and used to generate additional energy for storage in the batteries. In some embodiments, a mechanism can be provided in the housing 970 to lift the cooling fans into a higher position that allows the fans to capture more wind energy (e.g., by virtue of removing obstructions otherwise in the wind path and/or by placing the fans into a faster stream of wind). In still further examples, the fans themselves may be coupled to electrical motors or other powered mechanisms configured to rotate the fans to maximize the capture of wind energy passing through the blades of the fans. In some cases, the fans can be both vertically lifted and rotated for optimal alignment with the wind, using a combined mechanism or using separate lifting and rotational mechanisms for each fan. In some aspects, the housing 970 may itself be rotated to orient one or more fans to a more optimal position for extracting wind energy. For example, vehicle axis tracking can be implemented to orient (and re-orient) the housing 970 of the containerized mobile data center apparatus to optimize for solar energy generation during the daylight hours, with the vehicle axis tracking controlled to orient (and re-orient) the housing 970 to instead optimize for wind energy generation during the night hours, overcast conditions, and/or high-wind conditions in which maximum energy can be generated by optimizing the vehicle axis tracking to favor vehicle orientation driven by fan axis orientation into the wind.

Notably, the presently disclosed containerized mobile data center apparatus can be configured to operate as both a stationary, grid-independent data center and a solar-powered vehicle. In some embodiments, some (or all) of the solar panel platforms provided on the housing 970 can be controlled to remain at least partially open while the vehicle is in motion (e.g., while traveling between different deployment locations or geographic areas, etc.). By leaving at least some of the solar panel platforms in at least a partially open or deployed position, the containerized mobile data center apparatus can generate electrical power to augment (or fully meet) the power demands of the propulsion system used to move the containerized unit.

In some cases, the containerized unit can be configured to travel between locations using power accumulated to its onboard batteries (e.g., charged via the solar panel platform arrays). The containerized unit can include one or more monitoring systems capable of detecting when the onboard battery state of charge is running low or will otherwise become depleted prior to reaching the target location. For instance, the safety/monitoring unit 540 can be configured to perform the battery system state of charge monitoring and corresponding control of the movement of the unit and deployment of its power generation module(s). In some cases, when the mobile data center apparatus detects that its onboard batteries are running low, the mobile data center apparatus may locate and travel to a suitable parking location in which it may expose, deploy, or unfold more solar panel platforms. When parked, solar energy can be accumulated from just the top of the housing 970 or alternatively, solar energy can additionally be accumulated by unfolding one or more arrays of solar panel platforms provided about the vertical sides of the housing 970. Upon determining that sufficient charge has been accumulated to the onboard batteries, the solar panel platforms can be folded and stowed (if needed) and the mobile data center vehicle can continue traveling to move itself to its next location.

As mentioned previously, the containerized mobile data centers disclosed herein can be implemented as towed apparatuses and/or can be implemented as self-propelled apparatuses or vehicles. In some embodiments, both towed apparatus and self-propelled/vehicle apparatus implementations can include a tracking and orientation system for rotating and otherwise repositioning the apparatus within a particular location (e.g., such as while the apparatus is deployed and performing power generation). In one illustrative example, the tracking and orientation system can be a two-axis tracking system.

For example, solar panels are most effective when the incident light (e.g., the rays of the sun) are directly perpendicular to the surface of the solar panels. The sun moves both seasonally and across the daylight hours of each individual day. Accordingly, maximizing the time spent by solar panels in a configuration perpendicular to the sun (or otherwise minimizing the angle away from perpendicular) can be implemented based on controllable rotation and orientation of the solar panel arrays/

In some embodiments, the systems and techniques described herein can be used to perform yaw axis tracking. For instance, the containerized mobile data center apparatus can be provided on wheels or other locomotion/movement means. Accordingly, a chassis motor can be used to orient the chassis (e.g., housing) of the mobile data center unit such that the back of the mobile data center unit is always closest to the sun. By keeping the back of the mobile data center unit closest to the sun, the solar panel platforms can be oriented to track the movement of the sun in a manner that maintains the perpendicular (or near perpendicular) orientation between the upper surface of the solar panels and the incident sunlight. In some embodiments, multiple containerized mobile data center units can be parked nearby or adjacent to one another, in which case the multiple units can be coordinated to park in a line running in the North-South direction to minimize the extent to which any particular mobile data center unit casts a shadow on the solar panel arrays of other (e.g., adjacent) mobile data center units.

Pitch axis tracking can be performed based on lifting one or more of the front or rear ends of the containerized housing in the vertical direction, such that an offset angle or tilt is created between the front and rear ends of the containerized housing. For example, pitch axis tracking can be performed to lift the solar panel platforms from a position in which the solar panel platforms (and the top/bottom surfaces of the containerized housing) are parallel to the surface of the ground to a tilted position that is several degrees away from parallel, but perpendicular to the incident sunlight. In some embodiments, the pitch axis tracking can be implemented using a lifting mechanism that utilizes one or more levers (or other mechanical advantage mechanism/force multipliers) to more easily perform the requisite lifting of the front or rear end of the containerized housing. For instance, the onboard batteries of the containerized mobile data center apparatus may represent a significant or majority percentage of the overall weight. In such examples, the onboard batteries (and/or other mass within the containerized housing) can be located toward either the front or rear end of the containerized housing. The containerized housing can be provided on a fulcrum, using a hinge or wheeled axis system, such that the mechanical force needed to lift the opposite end of the containerized housing (away from the mass-concentrated end) is reduced. In some embodiments, the mass concentration in one end of the containerized housing and/or the fulcrum placement and configuration can be implemented such that the opposite end of the containerized housing naturally attempts to rise upward. Accordingly, a motor system associated with the pitch axis tracking can be configured to actively hold down the un-weighted end of the containerized housing in the level position that is parallel to the ground surface, providing slack or reduced force to permit the un-weighted end of the containerized housing to rise upwards by a desired amount or desired angular displacement. In some aspects, the containerized mobile data center apparatus can include various sensors, detectors, etc., that provide information to an onboard feedback system (e.g., including in safety/monitoring unit 540) that continuously optimizes for the pitch axis tilt angle that generates the most electrical power from the solar panel platform arrays, subject to constraints on the maximum angle of the system that is stable for the current configuration (e.g., the extent to which the solar panel platforms are unfolded and/or extended) and stable for the current environmental conditions (e.g., winds, weather, etc.).

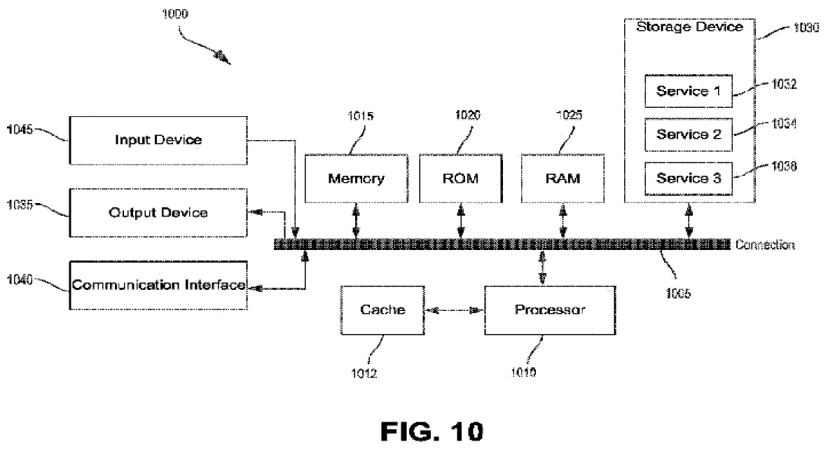

In some examples, the systems and techniques described herein can be implemented or otherwise performed by a computing device, apparatus, or system. In one example, the systems and techniques described herein can be implemented or performed by a computing device or system having the computing device architecture 10000 of FIG. 10. The computing device, apparatus, or system can include any suitable device, such as a mobile device (e.g., a mobile phone), a desktop computing device, a tablet computing device, a wearable device (e.g., a VR headset, an AR headset, AR glasses, a network-connected watch or smartwatch, or other wearable device), a server computer, an autonomous vehicle or computing device of an autonomous vehicle, a robotic device, a laptop computer, a smart television, a camera, and/or any other computing device with the resource capabilities to perform the processes described herein. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Processes described herein can comprise a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 10 illustrates an example computing device architecture 1000 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. The components of computing device architecture 1000 are shown in electrical communication with each other using connection 1005, such as a bus. The example computing device architecture 1000 includes a processing unit (CPU or processor) 1010 and computing device connection 1005 that couples various computing device components including computing device memory 1015, such as read only memory (ROM) 1020 and random-access memory (RAM) 1025, to processor 1010.

Computing device architecture 1000 can include a cache of high-speed memory connected directly with, in close proximity to, or integrated as part of processor 1010. Computing device architecture 1000 can copy data from memory 1015 and/or the storage device 1030 to cache 1012 for quick access by processor 1010. In this way, the cache can provide a performance boost that avoids processor 1010 delays while waiting for data. These and other engines can control or be configured to control processor 1010 to perform various actions. Other computing device memory 1015 may be available for use as well. Memory 1015 can include multiple different types of memory with different performance characteristics. Processor 1010 can include any general-purpose processor and a hardware or software service, such as service 1 1032, service 2 1034, and service 3 1036 stored in storage device 1030, configured to control processor 1010 as well as a special-purpose processor where software instructions are incorporated into the processor design. Processor 1010 may be a self-contained system, containing multiple cores or processors, a bus, memory controller, cache, etc. A multi-core processor may be symmetric or asymmetric.

To enable user interaction with the computing device architecture 1000, input device 1045 can represent any number of input mechanisms, such as a microphone for speech, a touch-sensitive screen for gesture or graphical input, keyboard, mouse, motion input, speech and so forth. Output device 1035 can also be one or more of a number of output mechanisms known to those of skill in the art, such as a display, projector, television, speaker device, etc. In some instances, multimodal computing devices can enable a user to provide multiple types of input to communicate with computing device architecture 1000. Communication interface 1040 can generally govern and manage the user input and computing device output. There is no restriction on operating on any particular hardware arrangement and therefore the basic features here may easily be substituted for improved hardware or firmware arrangements as they are developed.

Storage device 1030 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1025, read only memory (ROM) 1020, and hybrids thereof. Storage device 1030 can include services 1032, 1034, 1036 for controlling processor 1010. Other hardware or software modules or engines are contemplated. Storage device 1030 can be connected to the computing device connection 1005. In one aspect, a hardware module that performs a particular function can include the software component stored in a computer-readable medium in connection with the necessary hardware components, such as processor 1010, connection 1005, output device 1035, and so forth, to carry out the function.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as flash memory, memory or memory devices, magnetic or optical disks, flash memory, USB devices provided with non-volatile memory, networked storage devices, compact disk (CD) or digital versatile disk (DVD), any suitable combination thereof, among others. A computer-readable medium may have stored thereon code and/or machine-executable instructions that may represent a procedure, a function, a subprogram, a program, a routine, a subroutine, a module, an engine, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, engines, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. A grid-independent mobile data center apparatus, comprising: a housing; a plurality of computational units provided within an interior volume of the housing and configured to implement an edge data center; an onboard energy generation system deployable from the housing and configured to generate electrical energy for powering at least the plurality of computational units; a cooling system associated with the plurality of computational units and powered by the onboard energy generation system; one or more battery systems configured to store electrical energy generated by the onboard energy generation system; a communications system including one or more satellite transceivers, each satellite transceiver of the one or more satellite transceivers associated with a satellite internet constellation and configured to provide data connectivity between the satellite internet constellation and the plurality of computational units; and one or more propulsion systems coupled to the housing, the one or more propulsion systems configured to move the housing within a surrounding environment utilizing electrical energy from the onboard energy generation system.

Aspect 2. The grid-independent mobile data center apparatus of Aspect 1, wherein the one or more propulsion systems: receive electrical energy generated by the onboard energy generation system; or receive electrical energy discharged from the one or more battery systems.

Aspect 3. The grid-independent mobile data center apparatus of any of Aspects 1 to 2, wherein the one or more propulsion systems include one or more electric motors disposed within the housing and configured to generate horizontal translational forces for moving the grid-independent mobile data center apparatus from a first location to a second location different from the first location.

Aspect 4. The grid-independent mobile data center apparatus of Aspect 3, wherein the one or more electric motors are coupled to a drivetrain of the housing having a plurality of wheels or treads.

Aspect 5. The grid-independent mobile data center apparatus of any of Aspects 3 to 4, wherein: the one or more electric motors are coupled to a propellor or blower fan mounted on the housing; and the housing is included in a water-going vessel or a hovercraft.

Aspect 6. The grid-independent mobile data center apparatus of any of Aspects 1 to 5, wherein: the onboard energy generation system is configured to generate electrical energy for powering the plurality of computational units and the grid-independent mobile data center apparatus.

Aspect 7. The grid-independent mobile data center apparatus of any of Aspects 1 to 6, further comprising: an electrical distribution bus coupled to each electrical-powered component included in the grid-independent mobile data center apparatus; wherein the electrical distribution bus selectively receives electrical power as input from one or more of the onboard energy generation system and the one or more battery systems.

Aspect 8. The grid-independent mobile data center apparatus of any of Aspects 1 to 7, further comprising: one or more internal combustion engine (ICE) generators configured to generate electrical energy for powering the grid-independent mobile data center apparatus or for charging the one or more battery systems; and a fuel storage tank attached to the housing and coupled to the one or more ICE generators to provide fuel.

Aspect 9. The grid-independent mobile data center apparatus of Aspect 8, wherein the one or more ICE generators are automatically powered on based on a determination that an electrical load associated with the grid-independent mobile data center apparatus is greater than a threshold amount of a maximum output load currently associated with the onboard energy generation system.

Aspect 10. The grid-independent mobile data center apparatus of any of Aspects 1 to 9, wherein the one or more propulsion systems include an axis tracking system configured to rotate the housing about one or more axes of the housing

Aspect 11. The grid-independent mobile data center apparatus of Aspect 10, wherein the axis tracking system rotates the housing to achieve a particular orientation of the onboard energy generation system when the onboard energy generation system is deployed from the housing.

Aspect 12. The grid-independent mobile data center apparatus of Aspect 11, wherein: the onboard energy generation system includes one or more solar panels arranged on a plurality of solar panel platforms deployable from the housing; a yaw axis tracking motor of the axis tracking system is configured to yaw the housing based on a determined solar position relative to the housing; and a pitch axis tracking motor of the axis tracking system is configured to adjust a pitch of the housing away from level based on an angle formed between incident sunlight and the plurality of solar panel platforms.

Aspect 13. The grid-independent mobile data center apparatus of any of Aspects 11 to 12, wherein: the onboard energy generation system includes one or more wind turbines or rotors coupled to an outer surface of the housing; and a yaw axis tracking motor of the axis tracking system is configured to yaw the housing based on a determined wind direction associated with measured winds acting on the housing.

Aspect 14. The grid-independent mobile data center apparatus of Aspect 13, wherein the one or more wind turbines or rotors include a fan associated with the cooling system, the fan configured to: dissipate waste heat from an interior volume of the housing when coupled to the onboard energy generation system; and generate additional electrical energy based on being de-coupled from the onboard energy generation system and being coupled to the one or more battery systems.

Aspect 15. The grid-independent mobile data center apparatus of any of Aspects 1 to 14, wherein the edge data center implemented by the plurality of computational units is a content delivery network (CDN) node associated with the satellite internet constellation.

Aspect 16. The grid-independent mobile data center apparatus of any of Aspects 1 to 15, wherein the grid-independent mobile data center apparatus is included in a fleet comprising a plurality of grid-independent mobile data center apparatuses.

Aspect 17. The grid-independent mobile data center apparatus of Aspect 16, wherein the communications system includes one or more backhaul transceivers configured for point-to-point and relay communications between the grid-independent mobile data center apparatus and additional grid-independent mobile data center apparatuses included in the fleet.

Aspect 18. The grid-independent mobile data center apparatus of Aspect 17, wherein the one or backhaul transceivers include one or more of a microwave transceiver or a free space optical (FSO) transceiver coupled to the housing.

Aspect 19. The grid-independent mobile data center apparatus of any of Aspects 1 to 18, wherein the communications system includes a first satellite transceiver configured for communication with a first satellite internet constellation and a second satellite transceiver configured for communication with a second satellite internet constellation different from the first satellite internet constellation.

Aspect 20. The grid-independent mobile data center apparatus of any of Aspects 1 to 19, wherein the communications system includes a first satellite receiver configured to receive communications from the satellite internet constellation and a second satellite receiver configured to transmit communications to the satellite internet constellation.

Aspect 21. The grid-independent mobile data center apparatus of any of Aspects 1 to 20, wherein each satellite transceiver of the one or more satellite transceivers is configured to transmit and receive packet network data traffic from a first bird included in the satellite internet constellation, wherein the first bird communicates with a terrestrial internet gateway connected to a second bird included in the satellite internet constellation.

Aspect 22. An apparatus comprising means for performing any of the operations of Aspects 1 to 21.

Aspect 23. A non-transitory computer-readable storage medium having stored thereon instructions which, when executed by one or more processors, cause the one or more processors to perform any of the operations of Aspects 1 to 21.

Aspect 24. A method comprising any of the operations of Aspects 1 to 21.

What is claimed is:

1. A grid-independent mobile data center apparatus, comprising:
a housing;
a plurality of computational units provided within an interior volume of the housing and configured to implement an edge data center;
an onboard energy generation system deployable from the housing and configured to generate electrical energy for powering at least the plurality of computational units;
a cooling system associated with the plurality of computational units and powered by the onboard energy generation system;
one or more battery systems configured to store electrical energy generated by the onboard energy generation system;
a communications system including one or more satellite transceivers, each satellite transceiver of the one or more satellite transceivers associated with a satellite internet constellation and configured to provide data connectivity between the satellite internet constellation and the plurality of computational units; and
one or more propulsion systems coupled to the housing, the one or more propulsion systems configured to move the housing within a surrounding environment utilizing electrical energy from the onboard energy generation system.

2. The grid-independent mobile data center apparatus of claim 1, wherein the one or more propulsion systems:
receive electrical energy generated by the onboard energy generation system; or
receive electrical energy discharged from the one or more battery systems.

3. The grid-independent mobile data center apparatus of claim 1, wherein the one or more propulsion systems include one or more electric motors disposed within the housing and configured to generate horizontal translational forces for moving the grid-independent mobile data center apparatus from a first location to a second location different from the first location.

4. The grid-independent mobile data center apparatus of claim 3, wherein the one or more electric motors are coupled to a drivetrain of the housing having a plurality of wheels or treads.

5. The grid-independent mobile data center apparatus of claim 3, wherein:
the one or more electric motors are coupled to a propellor or blower fan mounted on the housing; and
the housing is included in a water-going vessel or a hovercraft.

6. The grid-independent mobile data center apparatus of claim 1, wherein:
the onboard energy generation system is configured to generate electrical energy for powering the plurality of computational units and the grid-independent mobile data center apparatus.

7. The grid-independent mobile data center apparatus of claim 1, further comprising:
an electrical distribution bus coupled to each electrical-powered component included in the grid-independent mobile data center apparatus;
wherein the electrical distribution bus selectively receives electrical power as input from one or more of the onboard energy generation system and the one or more battery systems.

8. The grid-independent mobile data center apparatus of claim 1, further comprising:
one or more internal combustion engine (ICE) generators configured to generate electrical energy for powering the grid-independent mobile data center apparatus or for charging the one or more battery systems; and
a fuel storage tank attached to the housing and coupled to the one or more ICE generators to provide fuel.

9. The grid-independent mobile data center apparatus of claim 8, wherein the one or more ICE generators are automatically powered on based on a determination that an electrical load associated with the grid-independent mobile data center apparatus is greater than a threshold amount of a maximum output load currently associated with the onboard energy generation system.

10. The grid-independent mobile data center apparatus of claim 1, wherein the one or more propulsion systems include an axis tracking system configured to rotate the housing about one or more axes of the housing

11. The grid-independent mobile data center apparatus of claim 10, wherein the axis tracking system rotates the housing to achieve a particular orientation of the onboard energy generation system when the onboard energy generation system is deployed from the housing.

12. The grid-independent mobile data center apparatus of claim 11, wherein:
the onboard energy generation system includes one or more solar panels arranged on a plurality of solar panel platforms deployable from the housing;
a yaw axis tracking motor of the axis tracking system is configured to yaw the housing based on a determined solar position relative to the housing; and
a pitch axis tracking motor of the axis tracking system is configured to adjust a pitch of the housing away from level based on an angle formed between incident sunlight and the plurality of solar panel platforms.

13. The grid-independent mobile data center apparatus of claim 11, wherein:
the onboard energy generation system includes one or more wind turbines or rotors coupled to an outer surface of the housing; and
a yaw axis tracking motor of the axis tracking system is configured to yaw the housing based on a determined wind direction associated with measured winds acting on the housing.

14. The grid-independent mobile data center apparatus of claim 13, wherein the one or more wind turbines or rotors include a fan associated with the cooling system, the fan configured to:
dissipate waste heat from an interior volume of the housing when coupled to the onboard energy generation system; and
generate additional electrical energy based on being de-coupled from the onboard energy generation system and being coupled to the one or more battery systems.

15. The grid-independent mobile data center apparatus of claim 1, wherein the edge data center implemented by the plurality of computational units is a content delivery network (CDN) node associated with the satellite internet constellation.

16. The grid-independent mobile data center apparatus of claim 1, wherein the grid-independent mobile data center apparatus is included in a fleet comprising a plurality of grid-independent mobile data center apparatuses.

17. The grid-independent mobile data center apparatus of claim 16, wherein the communications system includes one or more backhaul transceivers configured for point-to-point and relay communications between the grid-independent mobile data center apparatus and additional grid-independent mobile data center apparatuses included in the fleet.

18. The grid-independent mobile data center apparatus of claim 17, wherein the one or backhaul transceivers include one or more of a microwave transceiver or a free space optical (FSO) transceiver coupled to the housing.

19. The grid-independent mobile data center apparatus of claim 1, wherein the communications system includes a first satellite transceiver configured for communication with a first satellite internet constellation and a second satellite transceiver configured for communication with a second satellite internet constellation different from the first satellite internet constellation.

20. The grid-independent mobile data center apparatus of claim 1, wherein the communications system includes a first satellite receiver configured to receive communications from the satellite internet constellation and a second satellite receiver configured to transmit communications to the satellite internet constellation.

21. The grid-independent mobile data center apparatus of claim 1, wherein each satellite transceiver of the one or more satellite transceivers is configured to transmit and receive packet network data traffic from a first bird included in the satellite internet constellation, wherein the first bird communicates with a terrestrial internet gateway connected to a second bird included in the satellite internet constellation.
